(19) United States
(12) Patent Application Publication
(10) Pub. No.: US 2026/0343611 A1
(43) Pub. Date: Oct. 29, 2026

(54) NEIGHBOR CELL INTERFERENCE PATTERN

(71) Applicant: QUALCOMM Incorporated, San Diego, CA (US)

(72) Inventors: Qian ZHANG, Basking Ridge, NJ (US); Tao LUO, San Diego, CA (US); Yan ZHOU, San Diego, CA (US); Junyi LI, Greentown, PA (US); Navid ABEDINI, Basking Ridge, NJ (US); Xiaoxia ZHANG, San Diego, CA (US); Mostafa KHOSHNEVISAN, San Diego, CA (US)

(21) Appl. No.: 19/577,162

(22) Filed: Mar. 24, 2026

Related U.S. Application Data
(60) Provisional application No. 63/794,151, filed on Apr. 24, 2025.

(51) Int. Cl. H04W 74/0808; H04B 7/06; H04B 17/318

(52) U.S. Cl. CPC H04W 74/0825; H04B 7/0626; H04B 17/328

(57) ABSTRACT

Certain aspects of the present disclosure provide techniques for neighbor cell interference pattern signaling. An example method includes obtaining, via serving cell(s), an interference indication of whether interference associated with neighbor cell(s) is expected to occur in transmission occasion(s) associated with an uplink-downlink pattern of the serving cell(s), the interference indication indicates that the interference is expected to occur in a first set of transmission occasions, the interference indication indicates that the interference is not expected to occur in a second set of transmission occasions, and the interference is associated with downlink communications via the serving cell(s); obtaining a configuration that indicates measurement resource(s), which include one or more of: the first set of transmission occasions or the second set of transmission occasions; obtaining measurement(s) via at least the measurement resource(s); and sending a channel state report that includes an indication of the measurement(s).

### CROSS-REFERENCE TO RELATED APPLICATION(S)

The present Application for Patent claims benefit of and priority to U.S. Provisional Application No. 63/794,151, filed Apr. 24, 2025, which is hereby expressly incorporated by reference herein in its entirety.

### INTRODUCTION

### Field of the Disclosure

Aspects of the present disclosure relate to wireless communications, and more particularly, to techniques for wireless communications based on a neighbor cell interference pattern.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells; obtaining a configuration that includes an indication of a first set of measurement resources, wherein the first set of measurement resources includes one or more of: the first set of transmission occasions or the second set of transmission occasions; obtaining one or more measurements via at least the first set of measurement resources; and sending a channel state report that includes an indication of the one or more measurements.

Certain aspects provide a method for wireless communications by a first network node. The method includes sending, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells; sending a configuration that includes an indication of a first set of measurement resources, wherein the first set of measurement resources includes one or more of: the first set of transmission occasions or the second set of transmission occasions; and obtaining a channel state report that includes an indication of one or more measurements associated with at least the first set of measurement resources.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIGS. 5A, 5B, and 5C depict example configurations for full-duplex communications.

FIG. 6 is a diagram illustrating an example of subband full duplex (SBFD) activation.

FIGS. 7A, 7B, and 7C depict examples of interference scenarios based on full-duplex communications.

FIG. 8 depicts an example wireless communications network where a network node employs SBFD communications.

FIGS. 9A and 9B depict examples of cross-link interference where a network node communicates in a full-duplex mode.

FIG. 10 depicts an example of a neighbor cell interference indication with respect to time-frequency resources associated with network nodes.

FIG. 11 depicts a process flow for signaling related to a neighbor cell interference indication.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for wireless communications based on a neighbor cell interference pattern.

A wireless communication network may include a number of devices and network entities employing techniques for exchanging information wirelessly. For example, a wireless communication network may include devices (e.g., user equipments (UEs)) and network entities (e.g., base stations (BSs), NodeBs, enhanced NodeBs (eNBs), next generation NodeBs (gNBs or gNodeBs), etc.) that wirelessly communicate data, control information, reference signals, etc. (e.g., according to various wireless communication network implementations). The wireless communication network may employ various technologies to improve throughput, achieve a high data rate, and/or improve the energy efficiency of the wireless communication network. These technologies may allow a wireless communication network to support communication between an increasing number of devices and network entities, support advanced functionalities at various devices, and improve the quality of communication between devices and network entities.

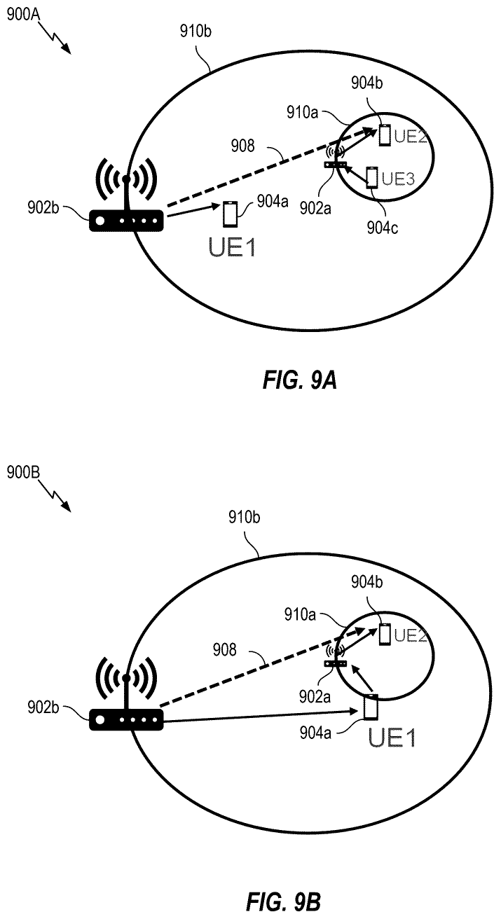

Network nodes and/or devices in a wireless communications network may encounter various types of interference. As described herein, one type of interference that affects wireless communications is cross-link interference (CLI). CLI may occur when a device (e.g., a UE or network node) is transmitting while another device is receiving in the same frequency band. As an example, uplink (UL) communications transmitted by a first device may cause CLI on downlink (DL) communications received by a second device. As another example, DL communications transmitted by a first device may cause CLI on DL communications received by the second device, for example, as further described herein with respect to FIGS. 9a and 9b.

In some aspects, the CLI may arise due to full-duplex communications. Technical problems for full-duplex communications may include, for example, effective interference management at a UE communicating with a network node that employs full-duplex communications. As an example, a first network node associated with a first cell (e.g., first coverage area) may employ full-duplex communications for concurrent transmission of DL communications and reception of UL communications with devices in a first cell of the first network node. The DL communications via the first cell may be in a given frequency band. In the case of CLI, a second network node, which has a second coverage area that overlaps with or is adjacent to the first cell, may transmit DL communications within the same frequency band as the DL communications of the first cell. Thus, the DL communications associated with the second network node may cause CLI for the DL communications associated with the first network node. In certain cases, the CLI from the second network node may affect the performance of wireless communications between UE(s) and the first network node.

Aspects described herein may overcome the aforementioned technical problem(s), for example, by providing certain schemes for wireless communications based on a neighbor cell interference pattern, which may enable reliable and accurate evaluation of the interference and/or certain measures to mitigate the effects of the interference encountered at a UE. In certain aspects, a UE may obtain an interference pattern that indicates transmission occasion(s) in which interference associated with a neighbor cell is expected to or not expected to occur. In certain cases, the interference pattern may indicate the frequency location(s) of interference associated with the neighbor cell. The interference pattern may enable the UE to know in which transmission occasions to measure the interference and/or the channel quality with or without interference for reporting channel state feedback (which may include a channel state report including an indication of one or more measurements associated with the interference). In certain cases, the interference pattern may indicate to the UE that the interference is expected to occur in a future time window, and thus, the interference pattern may enable the UE sufficient time to perform operations that effectively evaluate the interference and/or mitigate the effects of the interference. In certain cases, the interference pattern may indicate to the UE that the interference may include inter-network node or inter-cell CLI (for example, CLI that is output or emitted from a network node). Such an indication may indicate to the UE that the interference may be relatively strong compared to inter-UE interference, and thus, the UE may adapt its receive antenna diversity (e.g., increase the total number of receive antennas used to receive downlink signaling) to account for the stronger interference. In certain cases, the interference pattern may indicate to the UE that the interference is affecting a SBFD pattern associated with one or more serving cells, and thus, the UE may request to switch to a serving cell that is not affected by the interference.

As an example, the interference pattern may indicate a first set of transmission occasions in which interference associated with a neighbor cell is expected, and a second set of transmission occasions in which interference associated with the neighbor cell is not expected. In certain cases, the UE may report channel state information that indicates the channel quality in the first set of transmission occasions in which interference is expected, and the channel quality in the second set of transmission occasions in which interference is not expected.

Certain techniques for neighbor cell interference pattern signaling described herein may provide various beneficial technical effects and/or advantages. The techniques for neighbor cell interference pattern signaling may enable improved wireless communications performance, such as improved mitigation of inter-network node CLI, improved reliability of channel state feedback, improved accuracy of channel state feedback, and/or the like. The improved mitigation of CLI may be attributable to the neighbor cell interference pattern allowing a network node and/or UE to know when interference is expected and not expected to occur. As an example, the network node may configure communication parameters (such as adapting the modulation and coding scheme (MCS) between transmission occasions where interference is expected and not expected) to account for the interference in certain transmission occasions. As another example, the UE may anticipate or request retransmissions associated with downlink communications in transmission occasions in which interference is expected to occur. In certain cases, the UE may adjust the receive antenna diversity to increase the signal quality of received signaling in transmission occasions in which interference is expected to occur.

The improved reliability and/or accuracy of channel state feedback may be attributable to the neighbor cell interference pattern allowing a UE to know when to measure for the CLI and/or channel quality without CLI. As an example, the UE may report separate channel state information for the transmission occasions in which interference is expected and not expected to occur, respectively. Such channel state information may enable a network node to adapt communication parameters (such as an MCS), for example, based on the reported level of interference and/or channel quality encountered at the UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

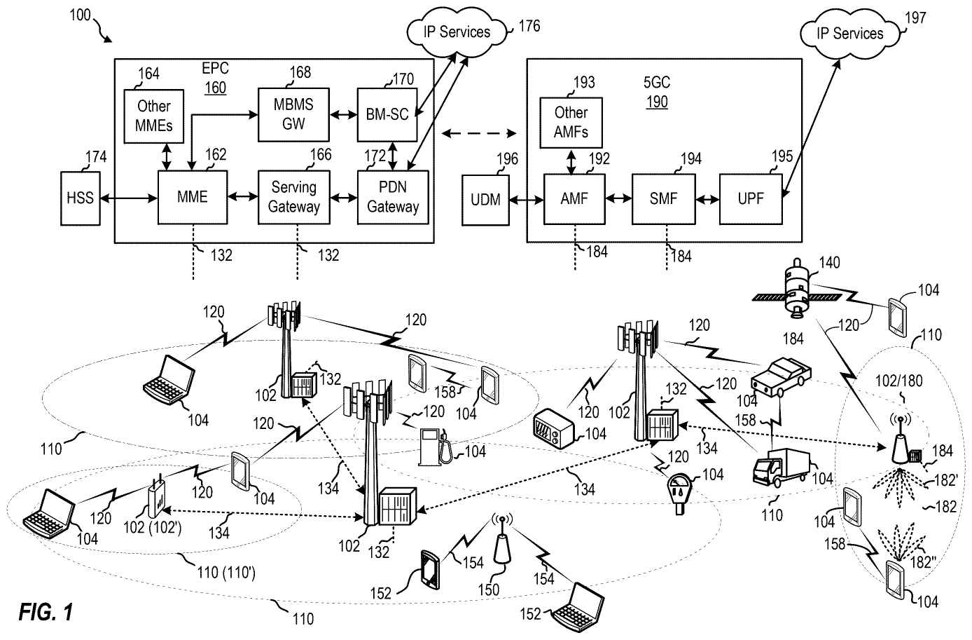

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

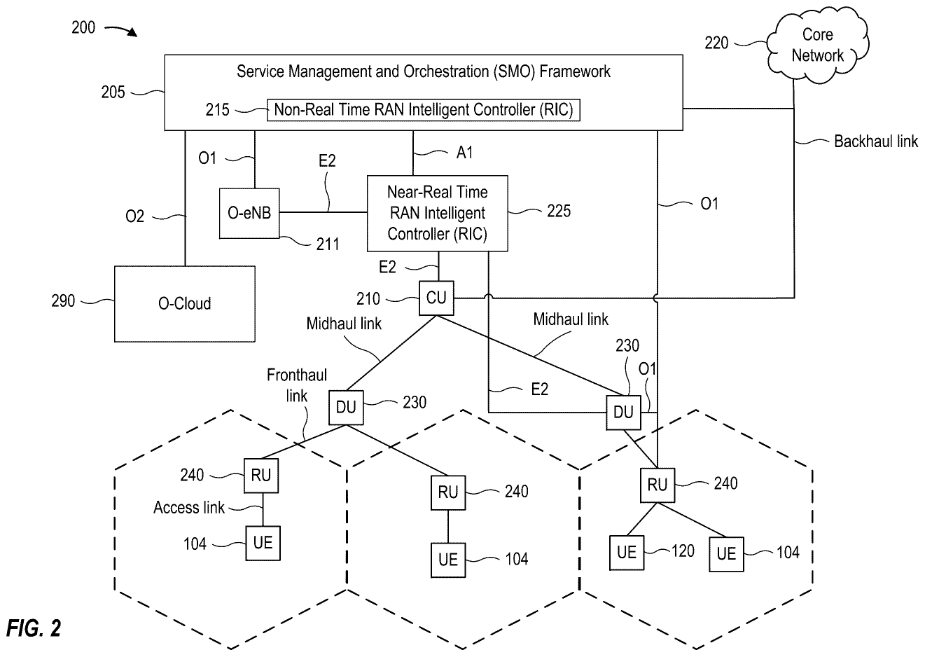

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

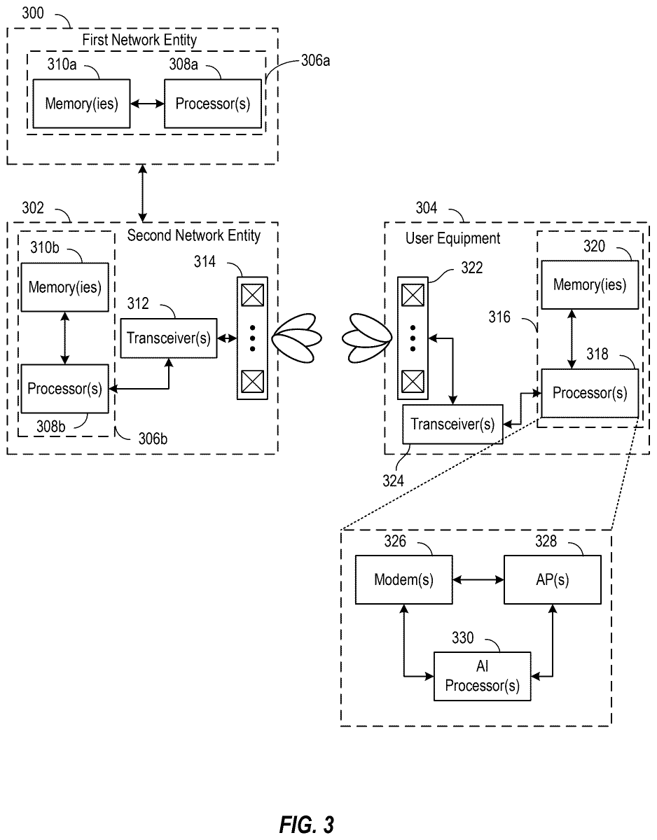

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

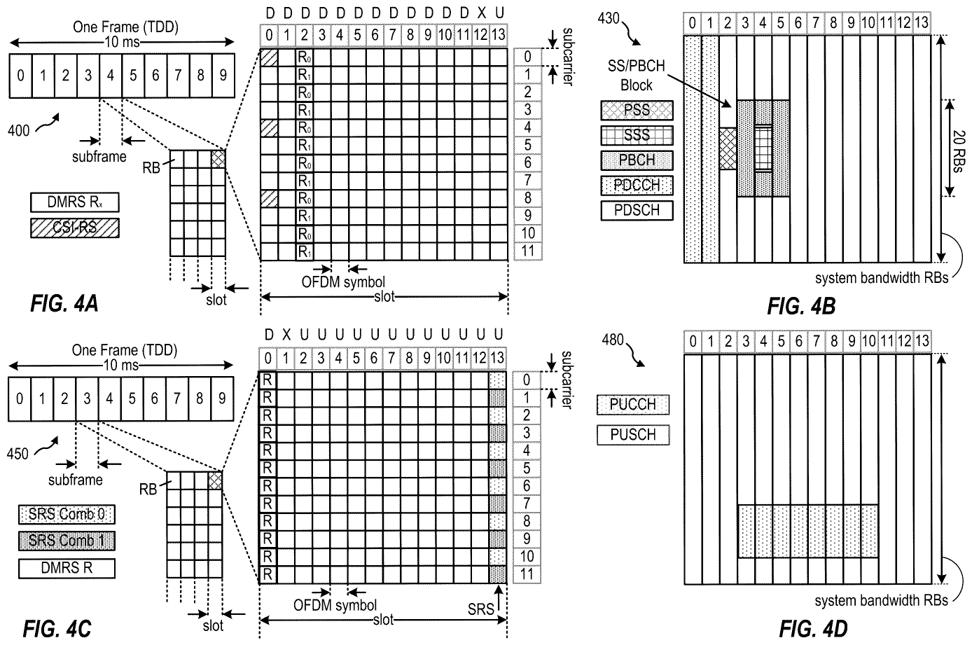

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Full-Duplex Communications

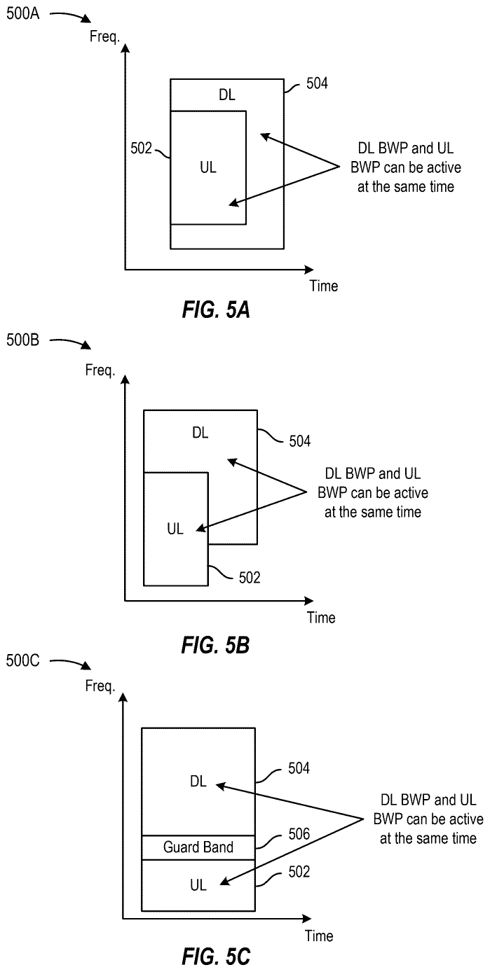

FIGS. 5A, 5B, and 5C depict example configurations for full-duplex communications. FIG. 5A depicts a first configuration 500A for full-duplex communications, FIG. 5B depicts a second configuration 500B for full-duplex communications, and FIG. 5C depicts a third configuration 500C for full-duplex communications. In some aspects, the first configuration 500A, the second configuration 500B, and the third configuration 500C may implement aspects of or may be implemented by aspects of FIG. 1-4D. In these examples, a network node and/or a UE may use the first configuration 500A, the second configuration 500B, or the third configuration 500C for full-duplex communications. In certain aspects, the network node may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3. Additionally, the first configuration 500A, the second configuration 500B, and the third configuration 500C may include aspects of the data structures for a wireless communications network depicted and described with respect to FIGS. 4A-4D.

As used herein, full-duplex communications in a wireless network refers to simultaneous bi-directional communication between devices in the wireless network. For example, a UE operating in a full-duplex mode may transmit an UL communication in an UL resource allocation 502 (e.g., an UL bandwidth part (BWP)) and receive a DL communication in a DL resource allocation 504 (e.g., a DL BWP) at the same time (e.g., in the same slot or the same symbol), and/or a network entity operating in a full-duplex mode may receive an UL communication in the UL resource allocation 502 and transmit a DL communication in the DL resource allocation 504 at the same time. Alternatively, half-duplex communications in a wireless network refers to unidirectional communications (e.g., only DL communication or only UL communication) between devices at a given time (e.g., in a given slot or a given symbol).

As shown in FIGS. 5A and 5B, the first configuration 500A and the second configuration 500B show examples of in-band full-duplex (IBFD) communication (sometimes referred to as “single-frequency full duplex” (SFFD)). In IBFD, the UE may transmit an UL communication to a network entity in the UL resource allocation 502 and receive a DL communication from the network entity in the DL resource allocation 504 on one or more same time and frequency resources, or the network entity may transmit a DL communication to a UE in the DL resource allocation 504 and receive an UL communication from the UE in the UL resource allocation 502 on one or more same time and frequency resources. As shown in the first configuration 500A, in a first example of IBFD, time and frequency resources for the UL resource allocation 502 may fully overlap with time and frequency resources for the DL resource allocation 504. As shown in the second configuration 500B, in a second example of IBFD, time and frequency resources for the UL resource allocation 502 may partially overlap with time and frequency resources for the DL resource allocation 504.

As further shown in FIG. 5C, the third configuration 500C shows an example of sub-band full-duplex (SBFD) communications, which may also be referred to as “sub-band frequency division duplex (SBFDD)” or “flexible duplex.” In SBFD, the UE may transmit an UL communication to a network entity in the UL resource allocation 502 and receive a DL communication from the network entity in the DL resource allocation 504 at the same time, but on different frequency resources. Additionally or alternatively, in SBFD, the network entity may transmit a DL communication to a UE in the DL resource allocation 504 and receive an UL communication from the UE in the UL resource allocation 502 at the same time, but on different frequency resources. For example, the different frequency resources may be sub-bands of a frequency band, such as a carrier, an operating band, and/or a TDD band. In this case, the frequency resources used for the DL resource allocation 504 may be separated from the frequency resources used for the UL resource allocation 502, in the frequency domain, by a guard band 506.

SBFD may increase an UL duty cycle, improve UL coverage, and reduce latency, because it is possible to transmit an UL signal in an UL sub-band in DL only or in flexible slots. SBFD may enhance system capacity, resource utilization, and spectrum efficiency. SBFD may enable flexible and dynamic UL and DL resource adaption according to UL and DL traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and messages for a RACH procedure. A random access channel (RACH) configuration may indicate a quantity of synchronization signal blocks (SSBs) per RACH occasion (RO) and power information for PRACH messages (e.g., preambles).

As indicated above, FIGS. 5A, 5B, and 5C are provided as examples. Aspects of the present disclosure may apply additional or alternative FD configuration(s) from what is described with respect to FIGS. 5A, 5B, and 5C.

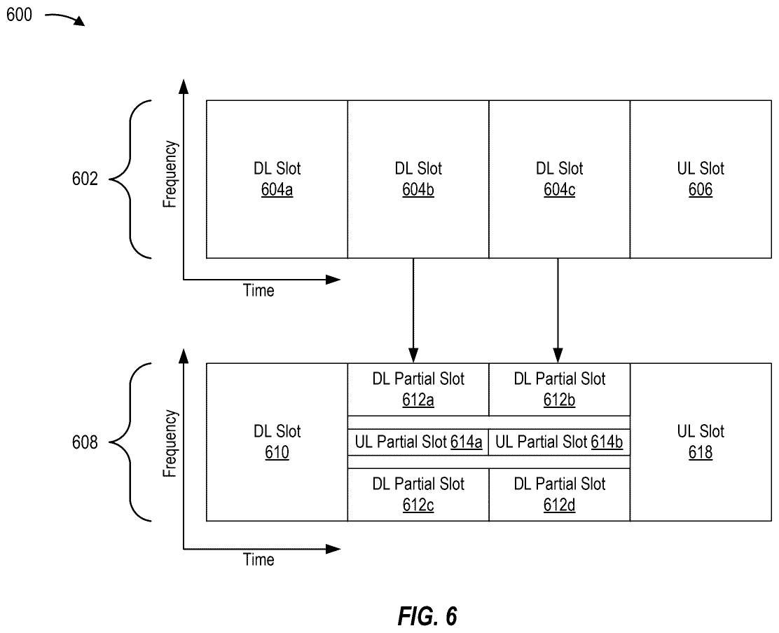

FIG. 6 is a diagram illustrating an example 600 of SBFD activation. As shown in FIG. 6, example 600 includes a first configuration 602. In some aspects, the first configuration 602 may indicate a first slot format pattern (sometimes called a TDD UL-DL pattern) associated with a half-duplex mode or a full-duplex mode. The first slot format pattern may include a quantity of downlink slots (e.g., three downlink slots 604a, 604b, and 604c, as shown), a quantity of flexible slots (not shown), and/or a quantity of uplink slots (e.g., one uplink slot 606, as shown). The first slot format pattern may repeat over time. In some aspects, a network entity (e.g., the BS 102) may indicate the first slot format pattern to a UE (e.g., the UE 104) using one or more slot format indicators. A slot format indicator, for a slot, may indicate whether that slot is an uplink slot, a downlink slot, or a flexible slot, among other examples.

In certain cases, the network entity may instruct (e.g., using an indication, such as a radio resource control (RRC) message, a medium access control (MAC) control element (CE) (MAC-CE), or downlink control information (DCI)) the UE to switch from the first configuration 602 to a second configuration 608 or to use the second configuration 608. As an alternative, the UE may indicate to the network entity that the UE is switching from the first configuration 602 to the second configuration 608. The second configuration 608 may indicate a second slot format pattern that repeats over time, similar to the first slot format pattern. In any of the aspects described above, the UE may switch from the first configuration 602 to the second configuration 608 during a time period (e.g., a quantity of symbols and/or an amount of time (e.g., in ms)) based at least in part on an indication received from the network entity (e.g., before switching back to the first configuration 602). During that time period, the UE may communicate using the second slot format pattern, and then the UE may revert to using the first slot format pattern after the end of the time period. The time period may be indicated by the network entity (e.g., via, by, or in the instruction to switch from the first configuration 602 to the second configuration 608, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by μ and associated with corresponding SCSs) with corresponding time periods for switching configurations.

In example 600, the second slot format pattern includes two SBFD slots in place of what were downlink slots in the first slot format pattern. In example 600, each SBFD slot includes a partial slot (e.g., a portion or sub-band of a frequency allocated for use by the network entity and the UE) for downlink (e.g., partial slots 612a, 612b, 612c, and 612d, as shown) and a partial slot for uplink (e.g., partial slots 614a and 614b, as shown). A partial slot may refer to a subband of a carrier allocated in a slot for wireless communications. Accordingly, the UE may operate using the second slot format pattern to transmit an uplink communication in an earlier slot (e.g., the second slot in sequence, shown as partial UL slot 614a) as compared to using the first slot format pattern (e.g., the fourth slot in sequence, shown as UL slot 606). Other examples may include additional or alternative changes. For example, the second configuration 608 may indicate an SBFD slot in place of what was an uplink slot in the first configuration 602 (e.g., UL slot 606). In another example, the second configuration 608 may indicate a downlink slot or an uplink slot in place of what was an SBFD slot in the first configuration 602 (not shown in FIG. 6). In yet another example, the second configuration 608 may indicate a downlink slot or an uplink slot in place of what was an uplink slot or a downlink slot, respectively, in the first configuration 602. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 6). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 602 to the second configuration 608, the network entity and the UE may experience increased quality and/or reliability of communications. For example, the network entity and the UE may experience increased throughput (e.g., using a full-duplex mode), reduced latency (e.g., the UE may be able to transmit an uplink and/or a downlink communication sooner using the second configuration 608 rather than the first configuration 602), and increased network resource utilization (e.g., by using both the DL BWP and the UL BWP simultaneously instead of only the DL BWP or the UL BWP). The techniques described herein use an indication from the network entity to the UE to instruct the UE to communicate using an SBFD mode, such as that shown in the second configuration 608.

As indicated above, FIG. 6 is provided as an example. Aspects of the present disclosure may apply to additional or alternative slot format patterns from what is described with respect to FIG. 6.

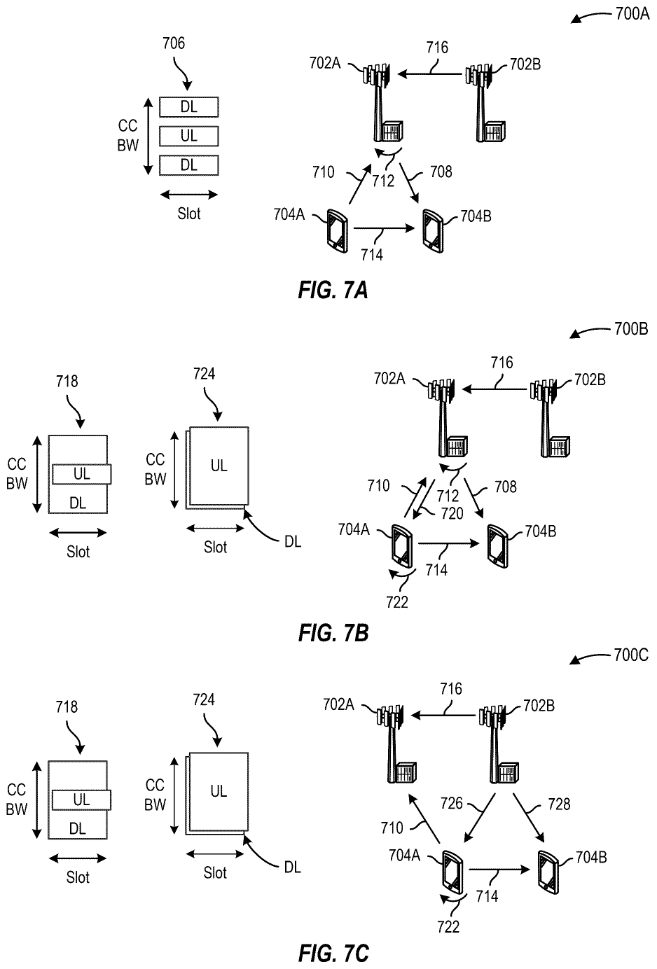

FIGS. 7A, 7B, and 7C depict examples of interference scenarios based on full-duplex communications. FIG. 7A depicts a first interference scenario 700A based on full-duplex communications, FIG. 7B depicts a second interference scenario 700B based on full-duplex communications, and FIG. 7C depicts a third interference scenario 700C based on full-duplex communications.

In some aspects, the first interference scenario 700A, the second interference scenario 700B, and the third interference scenario 700C may implement aspects of or may be implemented by aspects of FIG. 1-6. For example, the first interference scenario 700A, the second interference scenario 700B, and the third interference scenario 700C may include a first network entity 702A, a second network entity 702B, a first UE 704A, and a second UE 704B. In some aspects, the first network entity 702A and the second network entity 702B may be examples of the BS 102 depicted and described with respect to FIG. 1, the first network entity 300 or the second network entity 302 depicted and described with respect to FIG. 3, a disaggregated base station depicted and described with respect to FIG. 2, or the network entity described with respect to FIGS. 5A-5C. Similarly, the first UE 704A and the second UE 704B may be examples of the UE 104 depicted and described with respect to FIG. 1, the UE 304 depicted and described with respect to FIG. 3, or the UE described with respect to FIG. 5A-5C. Additionally, the first interference scenario 700A, the second interference scenario 700B, and the third interference scenario 700C may include aspects of the data structures for a wireless communications network depicted and described with respect to FIG. 4A-4D. FIGS. 7A, 7B, and 7C are provided as examples. Other examples of interference scenarios may differ from what is described with respect to FIGS. 7A, 7B, and 7C.

In the first interference scenario 700A depicted in the example of FIG. 7A, the first network entity 702A (e.g., a full-duplex gNB) may use a SBFD communication 706 (e.g., the SBFD communications depicted and described with respect to FIG. 5C) to concurrently communicate with the first UE 704A (e.g., a half-duplex UE) and the second UE 704B (e.g., a half-duplex UE). For example, the first network entity 702A may send a DL transmission 708 to the second UE 704B at the same time that the first UE 704A sends an UL transmission 710 to the first network entity 702A. In the first scenario 700A, the DL transmission 708 may result in a network entity self-interference 712 at the first network entity 702A when the first network entity 702A is attempting to decode the UL transmission 710. In some aspects, the UL transmission 710 may result in an inter-UE CLI 714 (e.g., an intra-cell UE-to-UE CLI) at the second UE 704B when the second UE 704B is attempting to decode the DL transmission 708.

Additionally, in the first scenario 700A depicted in the example of FIG. 7A, the second network entity 702B (e.g., a full-duplex gNB) may transmit a DL transmission to an additional UE (not shown) at the same time that the first UE 704A transmits the UL transmission 710 to the first network entity 702A. Accordingly, the DL transmission by the second network entity 702B may result in an inter-network entity CLI 716 (e.g., inter-gNB CLI) at the first network entity 702A when the first network entity 702A is attempting to decode the UL transmission 710.

In the second interference scenario 700B depicted in the example of FIG. 7B, the first network entity 702A (e.g., a full-duplex gNB) may concurrently use a full-duplex communication 718 (e.g., the partially-overlapping IBFD communications depicted and described with respect to FIG. 5A) or a full-duplex configuration 724 (e.g., the full-overlapping IBFD communications depicted and described with respect to FIG. 5B) to communicate with the first UE 704A (e.g., a full-duplex UE) and half-duplex communication to communicate with the second UE 704B (e.g., a half-duplex UE). For example, the first network entity 702A may transmit the DL transmission 708 to the second UE 704B at the same time that the first UE 704A transmits the UL transmission 710 to the first network entity 702A. At the same time, the first network entity 702A may transmit a DL transmission 720 to the first UE 704A. Accordingly, the DL transmission 708 or the DL transmission 720 may result in the network entity self-interference 712 at the first network entity 702A when the first network entity 702A is attempting to decode the UL transmission 710. In some aspects, the UL transmission 710 may result in a UE self-interference 722 at the first UE 704A when the first UE 704A is attempting to decode the DL transmission 720. Additionally, the UL transmission 710 may result in the inter-UE CLI 714 at the second UE 704B when the second UE 704B is attempting to decode the DL transmission 708. In some aspects, a DL transmission by the second network entity 702B may also result in the inter-network entity CLI 716 at the first network entity 702A when the first network entity 702A is attempting to decode the UL transmission 710.

In the third interference scenario 700C depicted in the example of FIG. 7C, the second network entity 702B may communicate with the first UE 704A (e.g., a full-duplex UE) and the second UE 704B (e.g., a half-duplex UE), where the first UE 704A uses the full-duplex communication 718 or the full-duplex configuration 724. As shown, the second network entity 702B may transmit a DL transmission 726 to the first UE 704A at the same time as transmitting a DL transmission 728 to the second UE 704B. At the same time, the first UE 704A may transmit the UL transmission 710 to the first network entity 702A. Accordingly, the UL transmission 710 may result in the UE self-interference 722 at the first UE 704A when (at the time at which) the first UE 704A is attempting to decode the DL transmission 726. Additionally, the UL transmission 710 may result in the inter-UE CLI 714 at the second UE 704B when the second UE 704B is attempting to decode the DL transmission 728. In some aspects, the DL transmission 726 or the DL transmission 728 may result in the inter-network entity CLI 716 at the first network entity 702A when the first network entity 702A is attempting to decode the UL transmission 710. In some aspects, the first network entity 702A and the second network entity 702B may be different transmission and reception points (TRPs) of a same network entity, where the same network entity is a multi-TRP entity.

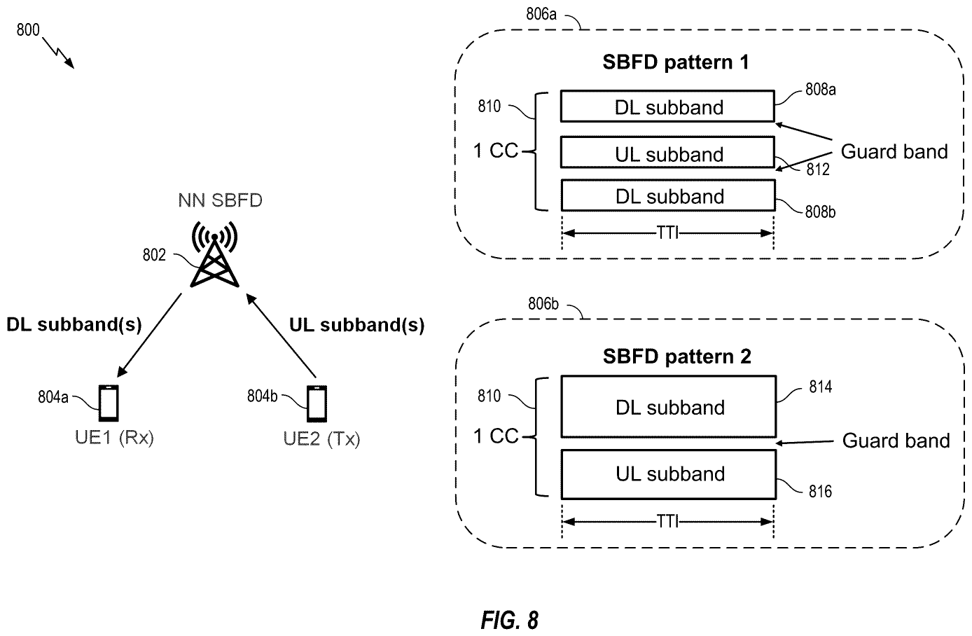

FIG. 8 depicts an example wireless communication network where a network node 802 employs SBFD communications to communicate with multiple UEs 804a, 804b. In this example, the network node 2 may simultaneously serve DL and UL UEs (e.g., the UEs 804a, 804b) on corresponding subbands of a SBFD pattern, such as a first SBFD pattern 806a or a second SBFD pattern 806b. The UEs 804a, 804b may communicate in half-duplex mode or full-duplex mode.

In the first SBFD pattern 806a, the network node 802 may transmit DL communications in a first DL subband 808a and/or a second DL subband 808b in a carrier 810 (e.g., a component carrier (CC)). The network node 802 may receive UL communications in an UL subband 812 arranged between the first DL subband 808a and the second DL subband 808b in the frequency domain. In the second SBFD pattern 806b, the network node 802 may transmit DL communication in a DL subband 814 in the carrier 810 and receive UL communications in an UL subband 816 in the carrier 810. A guard band may be arranged between a DL subband and an UL subband as described herein with respect to FIG. 5C. The DL subband(s) and UL subband of an SBFD may be allocated in a transmission time interval (TTI), such as a symbol and/or slot, for example, as described herein with respect to FIG. 6.

As an example, the network node 802 may transmit DL communications to a first UE 804a via DL subband(s) (e.g., the first DL subband 808a) of the SBFD pattern, and the network node 802 may receive UL communication from a second UE 804b via UL subband(s) (e.g., the UL subband 812) of the SBFD pattern.

FIGS. 9A and 9B depict examples 900A, 900B of cross-link interference that may be encountered where a network node communicates in a FD mode (e.g., SBFD mode). In these examples, a first network node 902a may be serving a first coverage area 910a associated with a first cell, and a second network node 902b may be serving a second coverage area 910b associated with a second cell. The first coverage area 910a may be arranged inside the second coverage area 910b, such that the first network node 902a and the second network node 902b form a heterogeneous wireless network (HetNet). As an example, the second coverage area 910b may be a macro cell, and the first coverage area may be a small cell (such as a pico cell, femto cell, or low power cell). Thus, with respect to the UE(s) served by the first network node 902a, the first cell may be a serving cell, and the second cell may be a neighbor cell. As used herein, “neighbor cell” may refer to a cell having a coverage area adjacent to or overlapping with the coverage area of a serving cell. “Serving cell” may refer to a cell via which a UE is in communication with a network node.

The first network node 902a may communicate in a full-duplex mode, such as an IBFD mode or an SBFD mode as described herein with respect to FIGS. 6, 7A-C, and FIG. 8. The second network node 902b may communicate via a TDD UL-DL slot pattern (such as a half-duplex slot format of DDDDU, where “D” indicates a downlink slot and “U” indicates an uplink slot).

Referring to FIG. 9A, a first UE 904a (shown as UE1) may be receiving DL communications from the second network node 902b. A second UE 904b (shown as UE2) may be receiving DL communications from the first network node 902a (for example, in the DL partial slot 612a); and a third UE 904c (shown as UE3) may be transmitting UL communications to the first network node 902a (for example, in the UL partial slot 614a of FIG. 6). Thus, the second UE 904b may encounter CLI 908 from the DL communications associated with the second cell of the second network node 902b. The second cell may be a neighbor cell with respect to the serving cell(s) of the second UE 904b (for example, the second cell of the second network node 902b).

The SBFD slot pattern associated with the first network node 902a may be distributed among multiple UEs. For example, with respect to the second configuration 608 of FIG. 6, the first network node 902a may configure the second UE 904b with a DDDU slot pattern and the third UE 904c with a DUUD slot pattern. The frequency resources of the DDDU slot pattern for the second UE 904b may be allocated in the DL slot 610, DL partial slot 612a, DL partial slot 612b, and UL slot 618. The frequency resources of the DUUD slot pattern for the third UE 904c may be allocated in the DL slot 610, UL partial slot 614a, UL partial slot 614b, and UL slot 618.

With respect to FIG. 9B, the first UE 904a (shown as UE1) may be communicating in a FD mode with the first network node 902a and the second network node 902b (shown as UE2). For example, the first UE 904a may be receiving DL communications from the second network node 902b, and the first UE 904a may be transmitting UL communication to the first network node 902a. The second UE 904b may be receiving DL communications from the first network node 902a, for example, in the DL partial slot 612a. In certain cases, the second UE 904b may encounter CLI from the DL communications associated with the second cell of the second network node 902b.

Note that FIGS. 9A and 9B merely depict examples to facilitate an understanding of the CLI that may be encountered due to FD communications. Aspects of the present disclosure may be applied to alternative or additional network deployments, such as various inter-cell interference scenarios including inter-macro cell interference between adjacent or overlapping macro cells.

### Aspects Related to Neighbor Cell Interference Pattern Signaling

Aspects described herein provide certain scheme(s) for wireless communications based on a neighbor cell interference pattern, which may enable reliable and accurate evaluation of the interference and/or enable certain measures to mitigate the effects of interference encountered at the UE.

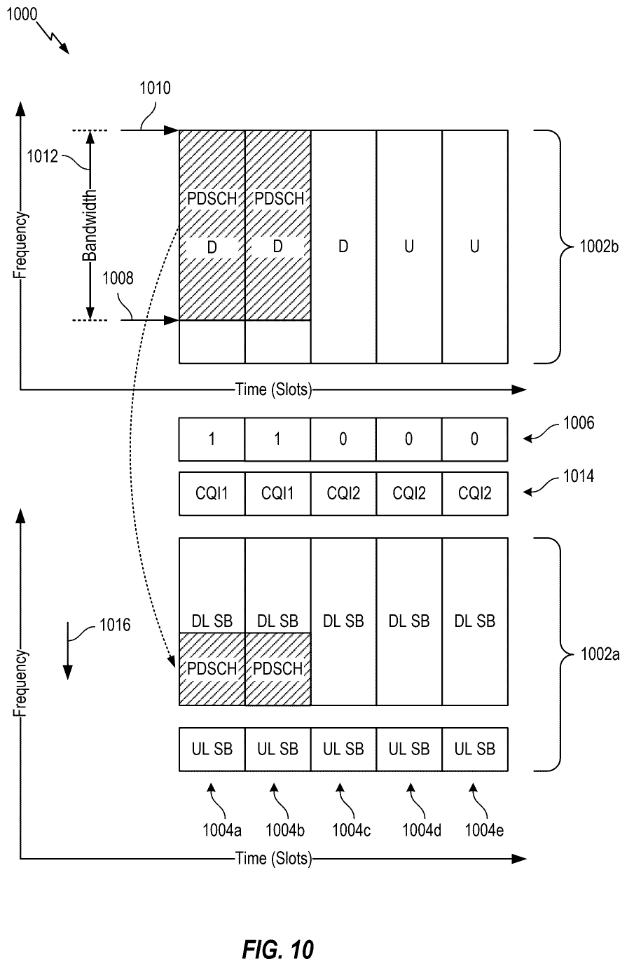

FIG. 10 depicts an example 1000 of a neighbor cell interference indication with respect to time-frequency resources associated with network nodes. In this example, a first network node (e.g., the first network node 902a) may communicate in a FD mode, for example, via a SBFD pattern (such as the second SBFD pattern 806b of FIG. 8). The SBFD pattern may include a set of DL subbands (DL SB) and a set of UL subbands (UL SB) arranged in (or occupy at least a portion of) a first carrier 1002a (or operating band) across a set of slots 1004a-e. Thus, the first network node may be able to communicate UL and DL signaling concurrently. In certain aspects, the first network node may distribute the time-frequency resources of the SBFD pattern among UEs, for example, as described herein with respect to FIGS. 9A and 9B.

Note that the SBFD pattern depicted in FIG. 10 is merely an example. Aspects of the present disclosure may apply to additional or alternative SBFD patterns, such as the first SBFD pattern 806a of FIG. 8.

A second network node (e.g., the second network node 902b) may communicate via a TDD UL-DL slot (or symbol) pattern, for example, a DDDUU slot pattern allocated across the set of slots 1004a-e. The second network node may serve a second coverage area associated with a second cell, for example, as described herein with respect to FIGS. 9A and 9B. The DL frequency channels and the UL frequency channels of the TDD UL-DL slot pattern may be arranged in (or occupy at least a portion of) a second carrier 1002b (or operating band). A PDSCH may be allocated in at least a portion of a DL frequency channel, for example, as shown by a diagonal fill in FIG. 10.

At least a portion of the PDSCH allocated for DL communications associated with the second network node may overlap in the frequency domain with at least a portion of a DL subband allocated for DL communications associated with the first network node. Thus, UE(s) communicating via a serving cell associated with the first network node may encounter interference associated with the neighbor cell of the second network node. The interference may interfere with the DL communications associated with the first network node. As used herein, interference associated with DL communications via a serving cell may refer to interference that interferes with DL communications via the serving cell, such as the DL signaling from the second network node.

For example, the interference with DL communications from the first network node may occur (or be expected to occur) in the first slot 1004a and the second slot 1004b. As another example, the interference associated with the neighbor cell may not occur (or be expected to occur) in certain DL slot(s) of the TDD UL-DL slot pattern (such as the third slot 1004c), for example, due to there not being any scheduled DL communications from the second network node in such slot(s). As another example, the interference associated with the neighbor cell may not occur (or be expected to occur) in uplink slots of the TDD UL-DL slot pattern associated with the second network node, such as the fourth slot 1004d and the fifth slot 1004e.

In certain aspects, the first network node may send, to a UE (e.g., the second UE 904b) via one or more serving cells (e.g., the first cell associated with the first coverage area 910a), an interference indication 1006 that indicates whether interference associated with one or more neighbor cells (e.g., the second cell associated with the second coverage area 910b) is expected to occur in one or more transmission occasions of a plurality of transmission occasions associated with an uplink-downlink pattern of the one or more serving cells (e.g., the SBFD pattern). A transmission occasion may refer to a transmission time interval of a TDD UL-DL pattern or a SBFD pattern, such as the first slot 1004a, the second slot 1004b, and so forth. In certain cases, the plurality of transmission occasions may be arranged in or correspond to a future time window. The interference indication 1006 may be communicated via RRC signaling, MAC signaling, system information, and/or DCI.

In certain cases, the UE may obtain the interference indication 1006 before the interference is expected to occur, for example, at 1016. For example, the UE may obtain the interference indication 1006 upon establishing a communication link with the first network node, for example, as part of an RRC configuration. As another example, the interference indication 1006 may be periodically broadcast with system information, such that the interference indication 1006 enables the UE to identify suitable DL channels via which to synchronize with the first network node (e.g., as a part of time-frequency synchronization for cell access). As another example, the interference indication 1006 may be communicated as part of a RACH procedure.

The interference indication 1006 may be or include an interference pattern that indicates whether the interference is expected to occur in each transmission occasion of the plurality of transmission occasions (e.g., slots 1004a-e). For example, the interference pattern may indicate that the interference is expected to occur in a first set of transmission occasions (for example, including the first slot 1004a and the second slot 1004b). The interference pattern may indicate that the interference is not expected to occur in a second set of transmission occasions (for example, including the third slot 1004c, the fourth slot 1004d, and the fifth slot 1004e). Note that, in some cases, the time unit granularity of the interference pattern may be in terms of symbols, milliseconds, any suitable unit of time, and/or the like.

In certain cases, the interference pattern may be or include a bit string (e.g., ‘1100011100’), where each bit of the bit string may correspond to a specific transmission occasion in a set or sequence of transmission occasions. In some examples, a value of ‘1’ of the bit string may indicate that the interference is expected to occur in the corresponding transmission occasion (e.g., slots 1004a, 1004b), and a value of ‘0 ’ indicates interference is not expected to occur in the corresponding transmission occasion (e.g., slots 1004c, 1004d, 1004e).

In certain aspects, the interference pattern may be periodic having a periodicity (e.g., every 5 ms, 10 ms, 20 ms, etc.). The periodicity of the interference pattern may have the same duration or different duration as the periodicity of the TDD UL-DL slot format or pattern of the second network node or the SBFD pattern of the first network node. In certain cases, the interference pattern may not be periodic, such that the interference pattern indicates the interference in an aperiodic or dynamic time window, for example, of a certain number of milliseconds (e.g., 5 ms, 10 ms, 20 ms, etc.). The time window may be a future time window.

In certain aspects, the interference indication 1006 may indicate or include a set of frequency resources (hereinafter “the interference band”) in which the interference is expected to occur (or occupy), for example, in the first set of transmission occasions. The interference band may be indicated via a frequency domain location (e.g., a start RB 1008 and/or an end RB 1010) and a bandwidth 1012 of the interference band (e.g., a frequency range or total number of RBs). The start RB 1008 may be the lowest RB or frequency of the interference band with respect to the frequency domain, and the end RB 1010 may be the highest RB or frequency of the interference band. The bandwidth 1012 may be the frequency range between the start RB 1008 and the end RB 1010. In certain cases, the interference band may occupy a contiguous range of frequency resources within the bandwidth 1012. In certain cases, the interference band may occupy a subset of frequency resources within the bandwidth 1012, for example, according to an interleaving pattern, a periodic pattern in the frequency domain, or the like.

The interference indication 1006 may indicate or include a separate interference band per transmission occasion of the first set of transmission occasions (and/or the plurality of transmission occasions). With respect to the second set of transmission occasions, the interference band may be indicated as having a bandwidth of zero or null length. The frequency band occupied by the interference (e.g., the interference band) may be indicated per transmission time interval (e.g., symbol or slot) of the interference indication 1006. The interference indication 1006 may indicate or include a common interference that corresponds to the first set of transmission occasions. For example, the frequency band occupied by the interference (e.g., the interference band) may be indicated via a common or single interference band across the symbols or slots of the interference pattern regardless of whether the interference occupies different frequency bands in the symbols or slots.

In certain cases, the interference band may be indicated via a frequency pattern index among a plurality of indexes, where each index corresponds to a different frequency resource pattern (e.g., a different arrangement of frequency resources) in which the interference is expected to occupy. The frequency pattern index may be indicated per period, per symbol, or per slot of the interference pattern (or the TDD slot pattern, or the SBFD pattern).

As the interference conditions may be different between the first set of transmission occasions and the second set of transmission occasions, the UE may be configured to obtain measurements of the channel quality and/or channel characteristics in the transmission occasions where there is neighbor cell interference and where there is no neighbor cell interference. In certain aspects, the first network node may send, to the UE, one or more configurations that include an indication of a set of measurement resources associated with channel state reporting or channel state measurement. A measurement resource may be or include one or more time-frequency resources allocated for measurement of a channel, signaling (such as one or more reference signals), and/or interference.

In certain cases, the set of measurement resources may include one or more channel measurement resources and/or one or more interference measurement resources. The set of measurement resources may be periodic or semi-persistent measurement resources. The UE may obtain one or more measurements or channel characteristic(s) via the set of measurement resources. The measurement(s) or channel characteristic(s) may include, for example, a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), a block error rate (BLER), and/or the like

In certain cases, the set of measurement resources may be configured into a first set of measurement resources associated with the first set of transmission occasions and a second set of measurement resources associated with the second set of transmission occasions. For example, a first configuration may include an indication of a first set of measurement resources, and a second configuration may include an indication of a second set of measurement resources. The first set of measurement resources may overlap or coincide with the first set of transmission occasions and the corresponding interference band. The second set of measurement resources may overlap or coincide with the second set of transmission occasions. Thus, the first set of measurement resources may enable the UE to measure the channel quality (or channel characteristics) when the interference associated with the neighbor cell is expected to occur, and the second set of measurement resources may enable the UE to measure the channel quality (or channel characteristics) when there is no interference expected to occur from the neighbor cell.

In certain cases, for the first set of measurement resources and corresponding channel state report, if a measurement occasion of the first set of measurement resources is outside, does not overlap with, or does not collide with the first set of transmission occasions, the UE may be configured to treat the measurement occasion as invalid. The UE may drop (e.g., refrain from using or including) any measurements obtained in the measurement occasion for a measurement report associated with the first set of transmission occasions. Thus, the measurement report for the first set of measurement resources may include only measurements that were obtained in measurement resource(s) that are inside or overlap with or collide with the first set of transmission occasions.

In certain cases, for the second set of measurement resources and corresponding channel state report, if a measurement occasion of the second set of measurement resources is inside, overlaps with, or collides with the first set of transmission occasions, the UE may be configured to treat the measurement occasion as invalid. The UE may drop (e.g., refrain from using or including) any measurement obtained in the measurement occasion for a measurement report associated with the second set of measurement occasions. Thus, the measurement report for the second set of measurement resources may include only measurements that were obtained in measurement resource(s) that are outside or do not overlap with or collide with the second set of transmission occasions.

In certain aspects, the set of measurement resources may be configured and/or used to measure the channel quality (or channel characteristics) in the first set of transmission occasions and the second set of transmission occasions. The set of measurement resources may overlap, coincide, or collide with (e.g., be inside) the transmission occasions and the corresponding interference band associated with the interference, such as the first set of transmission occasions. In certain cases, the set of measurement resources may overlap, coincide, or collide with (or be inside) the transmission occasions in which no interference is expected to occur, such as the second set of transmission occasions. Thus, the interference pattern may enable the UE to determine the particular measurement resource(s) of the set of measurement resources in which to measure the channel quality (or channel characteristics) when the interference is expected to occur. The interference pattern may enable the UE to determine the particular measurement resource(s) of the set of measurement resources in which to measure the channel quality (or channel characteristics) when the interference is not expected to occur.

For example, the UE may measure a first channel quality via one or more first measurement resources of the set of measurement resources that are inside, overlap, or collide with the first set of transmission occasions. The UE may measure a second channel quality via one or more second measurement resources of the set of measurement resources that are inside, overlap, or collide with the second set of transmission occasions. The UE may send a channel state report 1014 that indicates the first channel quality (e.g., CQI1) and the second channel quality (e.g., CQI2). Thus, the first channel quality may indicate the channel characteristics with neighbor DL interference, and the second channel quality may indicate the channel characteristics without neighbor DL interference (or at least without neighbor DL interference associated with the second network node). Note that CQI1 and CQI2 may be or include one or more channel characteristics, such as the CQI, RSSI, RSRP, SNR, and/or the like. For example, the UE may report two CQIs associated with a CSI report configuration that indicates two CQIs with or without neighbor DL interference, respectively. In some aspects, a single channel state report may include two CQIs, two RSSIs, and/or two SNRs, corresponding to measurements with or without neighbor DL interference, respectively. In certain cases, the CQIs (or channel characteristics) may be reported as or in association with two sub-configurations in one CSI report.

In certain cases, the set of measurement resources may be configured for aperiodic channel state measurements. In certain aspects, the channel state report may be configured as a type of report that is dedicated to reporting channel state information associated with an aperiodic or dynamic interference pattern. The set of measurement resources may have an irregular resource allocation in the time domain and/or frequency domain. For example, the UE may be configured with the set of measurement resources, and the UE may obtain, from the first network node, an indication (e.g., at 1016) to report a channel state report associated with the set of measurement resources, such as DCI that triggers an aperiodic channel state measurement. In some cases, the UE may be configured with the set of measurement resources within a certain duration from the transmission occasions of the interference pattern.

In certain cases, the UE may be configured to report the channel state with a periodicity, for example, with aperiodic interference measurement resources. In such cases, the interference measurement resource(s) of the set of measurement resources may be aperiodic (for example, dynamically configured), and the channel measurement resource(s) of the set of measurement resources may be periodic or semi-static. For a periodic instance of a channel measurement resource, the UE may select the interference measurement resource(s) that is the last, next, or closest interference measurement resource to the periodic instance of the channel measurement resource, where the interference measurement resource(s) overlaps or coincides with the first set of transmission occasions as indicated by the interference pattern. In certain cases, the selected interference measurement resources may be between the previous periodic instance and the current periodic instance of the channel measurement resources, where the UE may average the interference measurement resources.

In certain cases, the UE may be configured to report the channel state aperiodically or dynamically, for example, based on certain aperiodic trigger state(s). In such cases, the channel measurement resource pattern and the interference measurement resource pattern may be aperiodic (for example, configured dynamically). The aperiodic or dynamic resource allocation may enable the first network node to adapt the measurement resources to a specific interference pattern associated with the second network node. The channel measurement resource and the interference measurement resource may have a one-to-one mapping. In certain cases, the UE may be configured to report the channel state according to an aperiodic reporting pattern, for example, in a specific slot, such as slot 5, 8, 10, etc. The report pattern may be configured in a CSI report configuration, which may indicate a report type dedicated to reporting channel state information associated with an aperiodic interference pattern. The configuration(s) may include an indication to report the channel state report in a reporting occasion associated with an aperiodic reporting pattern, and an indication of the aperiodic reporting pattern (e.g., via an index).

The techniques described herein for neighbor cell interference pattern signaling may provide improved wireless communications performance, for example, by enabling mitigation of cross-link interference, enhancing the reliability of channel state feedback, increasing the accuracy of channel state feedback, and/or the like. The signaling of neighbor cell interference pattern(s) allows a network node and a UE to identify transmission occasion(s) during which interference is expected to occur and/or not occur. The interference pattern(s) enable adaptation of communication parameters and measurement configurations, facilitating channel state reporting that reflects the presence and/or absence of interference. As a result, the scheme(s) described herein support reliable and accurate evaluation of interference and allow for measures that mitigate its effects, contributing to enhanced performance of wireless communications. Accordingly, the interference pattern and/or the interference measurements may enable improved mitigation of inter-network node CLI (for example, encountered at a UE), improved reliability of channel state feedback, improved accuracy of channel state feedback, and/or the like.

### Example Signaling of Neighbor Cell Interference Pattern

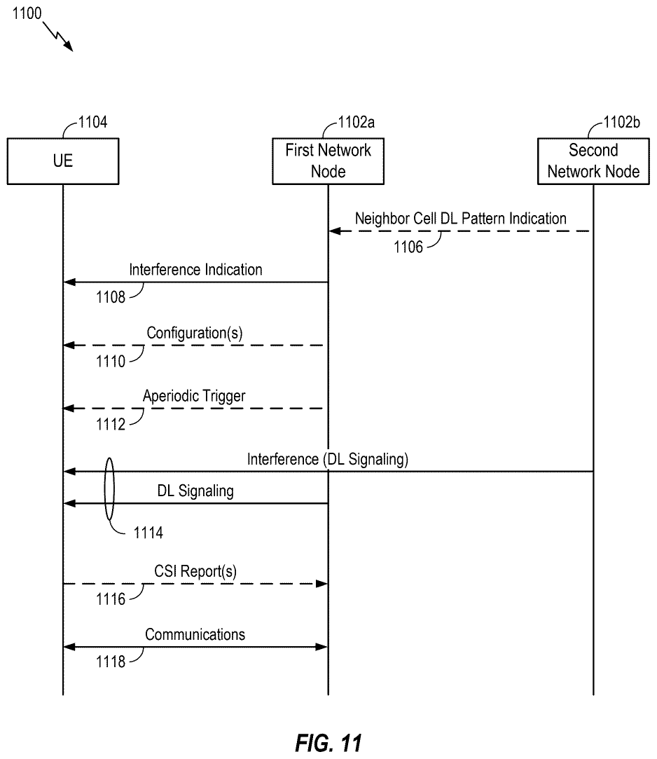

FIG. 11 depicts a process flow 1100 for signaling related to a neighbor cell interference indication in a system including a first network node 1102a, a second network node 1102b, and UE 1104. In some aspects, the network node 1102a, 1102b may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1104 may be an example of UE 104 depicted and described with respect to FIG. 1 or the UE 304 depicted and described with respect to FIG. 3. However, in other aspects, UE 1104 may be another type of wireless communications device, and network node 1102a, 1102b may be another type of network entity or network node, such as those described herein. Note that any operations or signaling illustrated with dashed lines may indicate that that operation or signaling is an optional or alternative example.

In this example, the first network node 1102a may be an example of the first network node 902a described herein with respect to FIGS. 9A, 9B, and 10. The second network node 1102b may be an example of the second network node 902b described herein with respect to FIGS. 9A, 9B, and 10. The UE 1104 may be an example of the second UE 904b described herein with respect to FIGS. 9A, 9B, and 10.

At 1106, the first network node 1102a optionally obtains, from the second network node 1102b, an indication of a neighbor cell downlink pattern. In certain aspects, the neighbor cell downlink pattern may include or indicate an interference pattern for the UE 1104, for example, via any of the indications or information associated with an interference pattern as described herein with respect to FIG. 10.

The neighbor cell downlink pattern may enable the first network node 1102a to determine the interference pattern for the UE 1104, for example, as described herein with respect to FIG. 10. For example, the first network node 1102a may identify the transmission occasions, associated with a SBFD pattern, that overlap with or collide with the downlink transmissions of the second network node 1102b in the time domain and/or frequency domain. The neighbor cell downlink pattern may indicate the time-frequency resources associated with downlink or flexible transmission time intervals (e.g., symbols or slots) in a TDD UL-DL pattern used by or at the second network node 1102b for downlink communications. For example, the second network node 1102b may share with the first network node 1102a the TDD UL-DL pattern that the second network node 1102b configures at UEs in communication with the second network node 1102b. The neighbor cell downlink pattern may indicate the transmission occasion(s) in which DL communications are actually (or expected to be) scheduled or used by or at the second network node 1102b. In certain cases, the neighbor cell downlink pattern may be based on or correspond to a semi-static configured DL frequency resource allocation, such as semi-persistent scheduling (SPS), periodic or semi-persistent CSI, or the like.

In certain cases, the neighbor cell downlink pattern may be a predicted pattern, for example, based on AI/ML model(s). In certain cases, the neighbor cell downlink pattern may correspond to certain neighbor cell(s) that can cause interference with UEs in communication with the first network node 1102a, such as neighbor cell(s) having a coverage area that overlaps with or is adjacent to the coverage area of the first network node 1102a. The neighbor cell DL pattern indication may be communicated via inter-node link(s), such as midhaul or backhaul links including an F1 interface, X2 interface, an Xn interface, and/or the like.

At 1108, the UE 1104 obtains, from the first network node 1102a, an interference indication, which may indicate an interference pattern, for example, as described herein with respect to FIG. 10. The interference indication may enable the UE 1104 to determine the transmission occasions in which to expect interference associated with the second network node 1102b. The interference indication may be communicated via RRC signaling, MAC signaling, DCI, system information, and/or the like.

At 1110, the UE 1104 optionally obtains, from the first network node 1102a, one or more configurations that include an indication of measurement resources for measuring the interference. For example, the configuration(s) may include a CSI report configuration that indicates a set of measurement resources for measurement of the channel state or characteristics, for example, to evaluate the effects of the interference from the second network node 1102b. The set of measurement resources may include periodic measurement resource(s), semi-persistent measurement resource(s), and/or aperiodic measurement resource(s). In certain cases, the set of measurement resources may include a first set of measurement resources and a second set of measurement resources. The first set of measurement resources may be configured to measure the channel state or characteristics in the transmission occasions that do not collide or overlap with the interference associated with the second network node 1102b, and the second set of measurement resources may be configured to measure the channel state or characteristics in the transmission occasions that do collide or overlap with the interference associated with the second network node 1102b. In certain cases, the UE 1104 may determine the first set of measurement resources and the second set of measurement resources based on the interference indication. In certain cases, the configuration(s) may include an indication of one or more channel state reports to report to the first network node 1102a. In certain cases, the configuration(s) may include the interference indication. The configuration(s) may be communicated via RRC signaling, MAC signaling, DCI, system information, and/or the like.

At 1112, the UE 1104 optionally obtains, from the first network node 1102 a, an aperiodic trigger that triggers the UE 1104 to measure and report channel characteristics(s), for example, to evaluate the effects of the interference associated with the second network node 1102b. The aperiodic trigger may indicate or include measurement resource(s) to use to measure the channel characteristics in transmission occasions that collide or overlap with the interference associated with the second network node 1102b. In certain cases, the aperiodic trigger may indicate or include measurement resource(s) to measure the channel characteristics in transmission occasions that do not collide or overlap with the interference associated with the second network node 1102b. The aperiodic trigger may be communicated via RRC signaling, MAC signaling, DCI, system information, and/or the like.

At 1114, the UE 1104 optionally obtains measurements via one or more measurement resources. The measurement resource(s) may be configured via the configuration(s) and/or indicated in the aperiodic trigger. For example, the UE 1104 may obtain signaling transmitted from the first network node 1102a and/or the second network node 1102b. In certain cases, the signaling may include one or more reference signals, such as an SSB, CSI-RS, DMRS, PT-RS, and/or the like. The UE 1104 may determine the measurement(s) based on the received signalling from the first network node 1102a and/or the second network node 1102b.

At 1116, the UE 1104 optionally sends, to the first network node 1102a, one or more CSI reports. The CSI report(s) may include an indication of the measurement(s) obtained at 1114, such as CQI, RSRP, RSSI, and/or SNR. The CSI report(s) may include a first set of measurements associated with transmission occasion(s) that overlap or collide with the interference (e.g., CQI1 of FIG. 10) and a second set of measurements associated with transmission occasion(s) that do not overlap or collide with the interference (e.g., CQI2 of FIG. 10).

At 1118, the UE 1104 communicates with the first network node 1102a, for example, based at least in part on the interference indication, the measurement(s), and/or the CSI report(s).

In certain cases, the interference indication may enable the UE 1104 to determine how to identify measurement resources to evaluate the effects of the interference associated with the second network node 1102b. For example, the interference indication may allow the UE 1104 to obtain channel characteristics in transmission occasions that overlap or collide with the interference and other channel characteristics in transmission occasions that do not overlap or collide with the interference. As another example, the UE 1104 may adjust the receive diversity in the transmission occasions that overlap or collide with the interference, such as increasing the antennas and the receive chains used to receive and process downlink signaling.

In certain cases, the CSI report(s) and/or interference indication may enable the first network node 1102a to determine how to adapt communication parameters (e.g., MCS, number of MIMO layers, channel bandwidth, etc.) for communications with the UE 1104 to account for the interference associated with the second network node 1102b. For example, the first network node 1102a may increase the code rate of downlink communications in transmission occasions that overlap or collide with the interference.

Accordingly, the interference pattern and/or the interference measurements may enable improved mitigation of inter-network node CLI, improved reliability of channel state feedback, improved accuracy of channel state feedback, and/or the like.

Note that the process flow illustrated in FIG. 11 is described herein to facilitate an understanding of a neighbor cell interference pattern, and aspects of the present disclosure may be performed in various manners via alternative or additional signaling and/or operations. In certain aspects, the operations and/or signaling of FIG. 11 may occur in an order different from that described or depicted, and various actions, operations, and/or signaling may be added, omitted, or combined.

### Example Operations of Neighbor Cell Interference Pattern Signaling

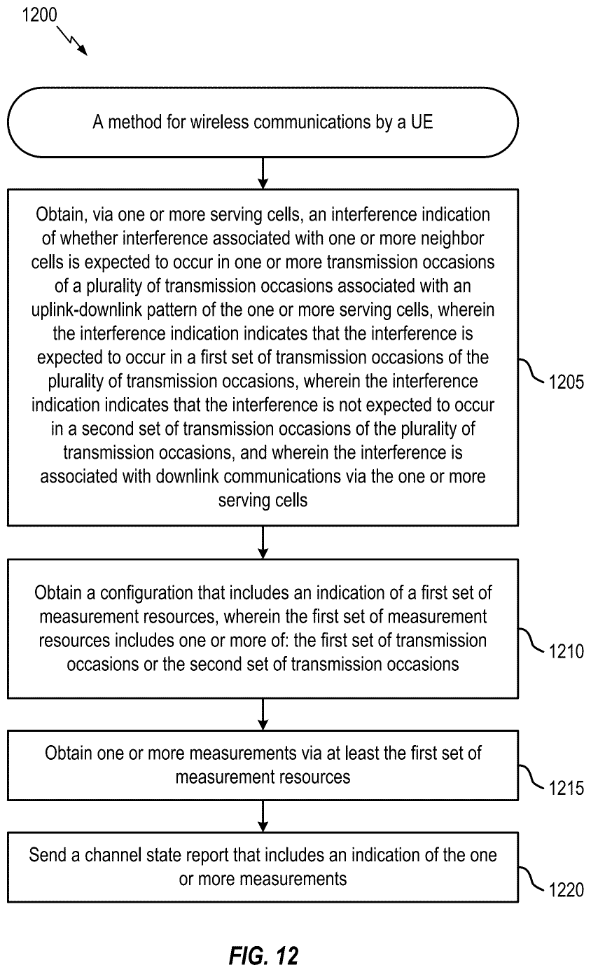

FIG. 12 shows a method 1200 for wireless communications by a UE, such as UE 104 of FIG. 1 or UE 304 of FIG. 3.

Method 1200 begins at block 1205 with obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells, for example, as described herein with respect to FIGS. 8-11.

Method 1200 then proceeds to block 1210 with obtaining a configuration that includes an indication of a first set of measurement resources, wherein the first set of measurement resources includes one or more of: the first set of transmission occasions or the second set of transmission occasions, for example, as described herein with respect to FIGS. 10 and 11.

Method 1200 then proceeds to block 1215 with obtaining one or more measurements via at least the first set of measurement resources, for example, as described herein with respect to FIGS. 10 and 11.

Method 1200 then proceeds to block 1220 with sending a channel state report that includes an indication of the one or more measurements, for example, as described herein with respect to FIGS. 10 and 11.

In some aspects, the first set of measurement resources includes one or more of: a set of channel measurement resources or a set of interference measurement resources.

In some aspects, the interference indication includes an interference pattern that indicates whether the interference is expected to occur in each transmission occasion of the plurality of transmission occasions associated with the uplink-downlink pattern of the one or more serving cells; and the plurality of transmission occasions, in the interference pattern, map to a plurality of slots or symbols in the uplink-downlink pattern.

In some aspects, the uplink-downlink pattern is part of a sub-band full-duplex pattern, in a time domain and a frequency domain, of the one or more serving cells.

In some aspects, the uplink-downlink pattern is based at least in part on a semi-static downlink resource allocation pattern or a predicted downlink resource allocation pattern.

In some aspects, the interference pattern has a periodicity.

In some aspects, the periodicity of the interference pattern matches a periodicity of the uplink-downlink pattern.

In some aspects, the periodicity of the interference pattern is different from a periodicity of the uplink-downlink pattern.

In some aspects, the interference pattern occupies an aperiodic time window.

In some aspects, the interference pattern indicates a set of frequency resources in which the interference is expected to occur in the first set of transmission occasions.

In some aspects, the interference pattern includes an indication of a location and a bandwidth of the set of frequency resources in a frequency domain.

In some aspects, the interference pattern indicates the set of frequency resources per transmission occasion of the first set of transmission occasions.

In some aspects, the interference pattern indicates the set of frequency resources occupies each transmission occasion of the first set of transmission occasions.

In some aspects, the interference pattern indicates the set of frequency resources based on an index associated with a frequency pattern.

In some aspects, the index is per period, per slot, or per symbol associated with the interference pattern.

In some aspects, the frequency pattern has a periodic pattern in a frequency domain.

In some aspects, the frequency pattern has an aperiodic frequency resource allocation.

In some aspects, the configuration includes an indication that the first set of measurement resources have a periodicity; and block 1215 includes obtaining the one or more measurements via a periodic instance of the first set of measurement resources that coincides in time with the first set of transmission occasions.

In some aspects, the first set of measurement resources includes the first set of transmission occasions; the configuration includes an indication of a second set of measurement resources, wherein the second set of measurement resources includes the second set of transmission occasions; and block 1215 includes obtaining the one or more measurements via the first set of measurement resources and the second set of measurement resources.

In some aspects, the configuration includes an indication that the second set of measurement resources have a periodicity; and block 1215 includes obtaining the one or more measurements via a periodic instance of the second set of measurement resources that coincides in time with the second set of transmission occasions.

In some aspects, the one or more measurements include: a first set of measurements associated with the first set of transmission occasions; and a second set of measurements associated with the second set of transmission occasions.

In some aspects, the first set of measurements includes one or more of a first channel quality indicator, a first received signal strength, or a first received signal quality; and the second set of measurements includes one or more of a second channel quality indicator, a second received signal strength, or a second received signal quality.

In some aspects, the channel state report includes: a first channel quality indicator associated with the first set of transmission occasions; and a second channel quality indicator associated with the second set of transmission occasions.

In some aspects, the channel state report indicates the first channel quality indicator in a first sub-configuration and the second channel quality indicator in a second sub-configuration.

In some aspects, the configuration includes an indication to report the channel state report with a reporting periodicity; the first set of measurement resources includes a set of channel measurement resources with a measurement periodicity and a set of interference measurement resources with an aperiodic measurement resource allocation; and block 1215 includes obtaining the one or more measurements via at least the set of interference measurement resources that is arranged in time between periodic instances of the set of channel measurement resources associated with the measurement periodicity.

In some aspects, the configuration includes an indication to report the channel state report with a reporting periodicity; the first set of measurement resources includes a set of channel measurement resources with a measurement periodicity and a set of interference measurement resources with an aperiodic measurement resource allocation; and block 1215 includes obtaining the one or more measurements via at least one interference measurement resource of the set of interference measurement resources that is next to, closest to, or after a periodic instance of the set of channel measurement resources associated with the measurement periodicity.

In some aspects, the configuration includes: an indication that the channel state report is a type of report that is dedicated to reporting channel state information associated with an aperiodic interference pattern; the first set of measurement resources includes a set of channel measurement resources and a set of interference measurement resources with an aperiodic measurement resource allocation; an indication to report the channel state report in a reporting occasion associated with an aperiodic reporting pattern; and an indication of the aperiodic reporting pattern.

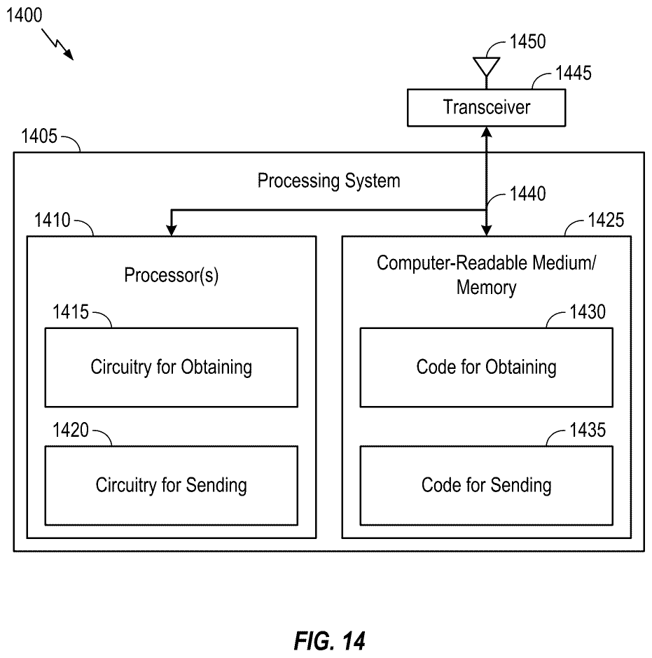

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

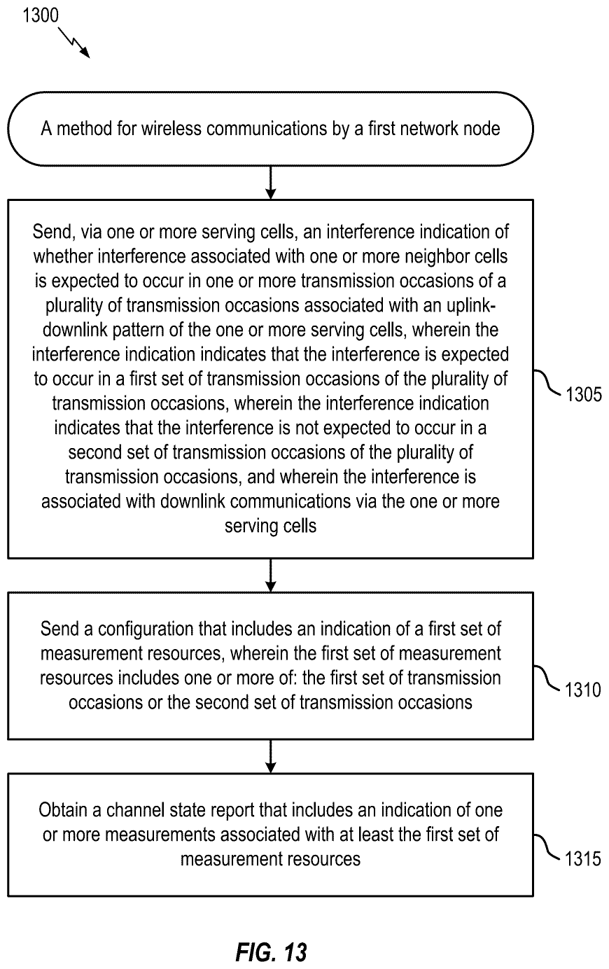

FIG. 13 shows a method 1300 for wireless communications by a first network node, such as BS 102 of FIG. 1, a first network entity 300 or second network entity 302 of FIG. 3, or a disaggregated base station as discussed with respect to FIG. 2.

Method 1300 begins at block 1305 with sending, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells, for example, as described herein with respect to FIGS. 8-11.

Method 1300 then proceeds to block 1310 with sending a configuration that includes an indication of a first set of measurement resources, wherein the first set of measurement resources includes one or more of: the first set of transmission occasions or the second set of transmission occasions, for example, as described herein with respect to FIGS. 10 and 11.

Method 1300 then proceeds to block 1315 with obtaining a channel state report that includes an indication of one or more measurements associated with at least the first set of measurement resources, for example, as described herein with respect to FIGS. 10 and 11.

In certain aspects, method 1300 further includes obtaining the interference indication from a second network node associated with the one or more neighbor cells, for example, where the second network node serves the one or more neighbor cells. In some aspects, obtaining the interference indication comprises obtaining, via an Xn interface or an F1 interface, the interference indication from the second network node.

In some aspects, the first set of measurement resources includes one or more of: a set of channel measurement resources or a set of interference measurement resources.

In some aspects, the interference indication includes an interference pattern that indicates whether the interference is expected to occur in each transmission occasion of the plurality of transmission occasions associated with the uplink-downlink pattern of the one or more serving cells; and the plurality of transmission occasions, in the interference pattern, map to a plurality of slots or symbols in the uplink-downlink pattern.

In some aspects, the uplink-downlink pattern is part of a sub-band full-duplex pattern, in a time domain and a frequency domain, of the one or more serving cells.

In some aspects, the uplink-downlink pattern is based at least in part on a semi-static downlink resource allocation pattern or a predicted downlink resource allocation pattern.

In some aspects, the interference pattern has a periodicity.

In some aspects, the periodicity of the interference pattern matches a periodicity of the uplink-downlink pattern.

In some aspects, the periodicity of the interference pattern is different from a periodicity of the uplink-downlink pattern.

In some aspects, the interference pattern occupies an aperiodic time window.

In some aspects, the interference pattern indicates a set of frequency resources in which the interference is expected to occur in the first set of transmission occasions.

In some aspects, the interference pattern includes an indication of a location and a bandwidth of the set of frequency resources in a frequency domain.

In some aspects, the interference pattern indicates the set of frequency resources per transmission occasion of the first set of transmission occasions.

In some aspects, the interference pattern indicates the set of frequency resources occupies each transmission occasion of the first set of transmission occasions.

In some aspects, the interference pattern indicates the set of frequency resources based on an index associated with a frequency pattern.

In some aspects, the index is per period, per slot, or per symbol associated with the interference pattern.

In some aspects, the frequency pattern has a periodic pattern in the frequency domain.

In some aspects, the frequency pattern has an aperiodic frequency resource allocation.

In some aspects, the configuration includes an indication that the first set of measurement resources have a periodicity; and a periodic instance of the first set of measurement resources coincides in time with the first set of transmission occasions.

In some aspects, the first set of measurement resources includes the first set of transmission occasions; the configuration includes an indication of a second set of measurement resources, wherein the second set of measurement resources includes the second set of transmission occasions; and the one or more measurements are associated with the first set of measurement resources and the second set of measurement resources.

In some aspects, the configuration includes an indication that the second set of measurement resources have a periodicity; and the one or more measurements are associated with a periodic instance of the second set of measurement resources that coincides in time with the second set of transmission occasions.

In some aspects, the one or more measurements include: a first set of measurements associated with the first set of transmission occasions; and a second set of measurements associated with the second set of transmission occasions.

In some aspects, the first set of measurements includes one or more of a first channel quality indicator, a first received signal strength, or a first received signal quality; and the second set of measurements includes one or more of a second channel quality indicator, a second received signal strength, or a second received signal quality.

In some aspects, the channel state report includes: a first channel quality indicator associated with the first set of transmission occasions; and a second channel quality indicator associated with the second set of transmission occasions.

In some aspects, the channel state report indicates the first channel quality indicator in a first sub-configuration and the second channel quality indicator in a second sub-configuration.

In some aspects, the configuration includes an indication to report the channel state report with a reporting periodicity; the first set of measurement resources includes a set of channel measurement resources with a measurement periodicity and a set of interference measurement resources with an aperiodic measurement resource allocation; and the one or more measurements is associated with at least the set of interference measurement resources that is arranged in time between periodic instances of the set of channel measurement resources associated with the measurement periodicity.

In some aspects, the configuration includes an indication to report the channel state report with a reporting periodicity; the first set of measurement resources includes a set of channel measurement resources with a measurement periodicity and a set of interference measurement resources with an aperiodic measurement resource allocation; and the one or more measurements is associated with at least one interference measurement resource of the set of interference measurement resources that is next to, closest to, or after a periodic instance of the set of channel measurement resources associated with the measurement periodicity.

In some aspects, the configuration includes: an indication that the channel state report is a type of report that is dedicated to reporting channel state information associated with an aperiodic interference pattern; the first set of measurement resources includes a set of channel measurement resources and a set of interference measurement resources with an aperiodic measurement resource allocation; an indication to report the channel state report in a reporting occasion associated with an aperiodic reporting pattern; and an indication of the aperiodic reporting pattern.

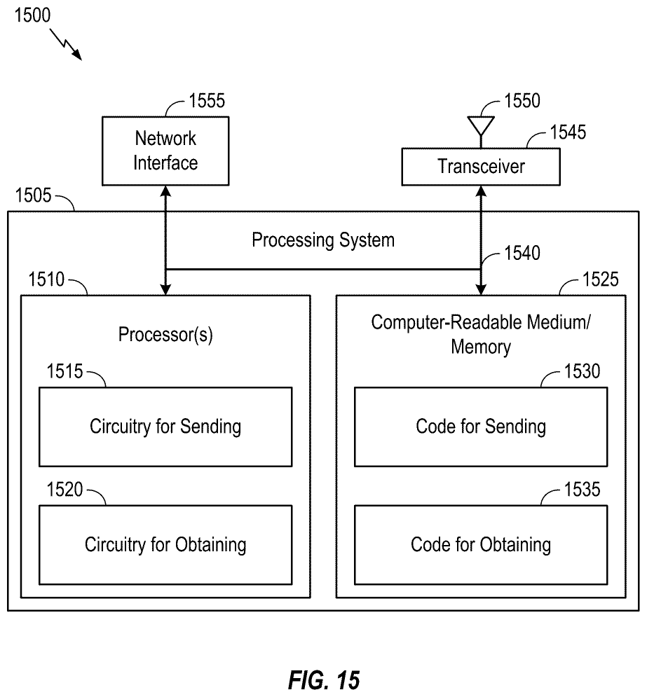

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for obtaining 1430 and code for sending 1435. Processing of the code 1430 and 1435 may enable and cause the communications device 1400 to perform the method 1200 described with respect to FIG. 12, or any aspect related to it. For instance, in some aspects, code for obtaining 1430 includes code for obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells. In some aspects, code for obtaining 1430 includes code for obtaining a configuration that includes an indication of a first set of measurement resources, wherein the first set of measurement resources includes one or more of: the first set of transmission occasions or the second set of transmission occasions. In some aspects, code for obtaining 1430 includes code for obtaining one or more measurements via at least the first set of measurement resources. In some aspects, code for sending 1435 includes code for sending a channel state report that includes an indication of the one or more measurements.

The one or more processors 1410 include circuitry configured to implement (e.g., execute) the code stored in the computer-readable medium/memory 1425, including circuitry for obtaining 1415 and circuitry for sending 1420. Processing with circuitry 1415 and 1420 may enable and cause the communications device 1400 to perform the method 1200 described with respect to FIG. 12, or any aspect related to it. For instance, in some aspects, circuitry for obtaining 1415 includes circuitry for obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells. In some aspects, circuitry for obtaining 1415 includes circuitry for obtaining a configuration that includes an indication of a first set of measurement resources, wherein the first set of measurement resources includes one or more of: the first set of transmission occasions or the second set of transmission occasions. In some aspects, circuitry for obtaining 1415 includes circuitry for obtaining one or more measurements via at least the first set of measurement resources. In some aspects, circuitry for sending 1420 includes circuitry for sending a channel state report that includes an indication of the one or more measurements.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1525. In various aspects, one or more processors 1510 may be representative of the one or more processors 308, as described with respect to FIG. 3. The one or more processors 1510 are coupled to the computer-readable medium/memory 1525 via a bus 1540. In certain aspects, the computer-readable medium/memory 1525 is configured to store instructions (e.g., computer-executable code), including code 1530 and 1535, that when executed by the one or more processors 1510, cause the one or more processors 1510 to perform the method 1300 described with respect to FIG. 13, or any aspect related to it, including any operations described in relation to FIG. 13. The computer-readable medium/memory 1525 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1525 stores code (e.g., executable instructions), including code for sending 1530 and code for obtaining 1535. Processing of the code 1530 and 1535 may enable and cause the communications device 1500 to perform the method 1300 described with respect to FIG. 13, or any aspect related to it. For instance, in some aspects, code for sending 1530 includes code for sending, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cel. In some aspects, code for sending 1530 includes code for sending a configuration that includes an indication of a first set of measurement resources, wherein the first set of measurement resources includes one or more of: the first set of transmission occasions or the second set of transmission occasions. In some aspects, code for obtaining 1535 includes code for obtaining a channel state report that includes an indication of one or more measurements associated with at least the first set of measurement resources.

The one or more processors 1510 include circuitry configured to implement (e.g., execute) the code stored in the computer-readable medium/memory 1525, including circuitry for sending 1515 and circuitry for obtaining 1520. Processing with circuitry 1515 and 1520 may enable and cause the communications device 1500 to perform the method 1300 described with respect to FIG. 13, or any aspect related to it. For instance, in some aspects, circuitry for sending 1515 includes circuitry for sending, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cel. In some aspects, circuitry for sending 1515 includes circuitry for sending a configuration that includes an indication of a first set of measurement resources, wherein the first set of measurement resources includes one or more of: the first set of transmission occasions or the second set of transmission occasions. In some aspects, circuitry for obtaining 1520 includes circuitry for obtaining a channel state report that includes an indication of one or more measurements associated with at least the first set of measurement resources.

Various components of the communications device 1500 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by a UE comprising: obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells; obtaining a configuration that includes an indication of a first set of measurement resources, wherein the first set of measurement resources includes one or more of: the first set of transmission occasions or the second set of transmission occasions; obtaining one or more measurements via at least the first set of measurement resources; and sending a channel state report that includes an indication of the one or more measurements.

Clause 2: The method of Clause 1, wherein the first set of measurement resources includes one or more of: a set of channel measurement resources or a set of interference measurement resources.

Clause 3: The method of any one of Clauses 1-2, wherein: the interference indication includes an interference pattern that indicates whether the interference is expected to occur in each transmission occasion of the plurality of transmission occasions associated with the uplink-downlink pattern of the one or more serving cells; and the plurality of transmission occasions, in the interference pattern, map to a plurality of slots or symbols in the uplink-downlink pattern.

Clause 4: The method of Clause 3, wherein the uplink-downlink pattern is part of a sub-band full-duplex pattern, in a time domain and a frequency domain, of the one or more serving cells.

Clause 5: The method of Clause 4, wherein the uplink-downlink pattern is based at least in part on a semi-static downlink resource allocation pattern or a predicted downlink resource allocation pattern.

Clause 6: The method of Clause 3, wherein the interference pattern has a periodicity.

Clause 7: The method of Clause 6, wherein the periodicity of the interference pattern matches a periodicity of the uplink-downlink pattern.

Clause 8: The method of Clause 6, wherein the periodicity of the interference pattern is different from a periodicity of the uplink-downlink pattern.

Clause 9: The method of Clause 3, wherein the interference pattern occupies an aperiodic time window.

Clause 10: The method of Clause 3, wherein the interference pattern indicates a set of frequency resources in which the interference is expected to occur in the first set of transmission occasions.

Clause 11: The method of Clause 10, wherein the interference pattern includes an indication of a location and a bandwidth of the set of frequency resources in a frequency domain.

Clause 12: The method of Clause 10, wherein the interference pattern indicates the set of frequency resources per transmission occasion of the first set of transmission occasions.

Clause 13: The method of Clause 10, wherein the interference pattern indicates the set of frequency resources occupies each transmission occasion of the first set of transmission occasions.

Clause 14: The method of Clause 10, wherein the interference pattern indicates the set of frequency resources based on an index associated with a frequency pattern.

Clause 15: The method of Clause 14, wherein the index is per period, per slot, or per symbol associated with the interference pattern.

Clause 16: The method of Clause 14, wherein the frequency pattern has a periodic pattern in a frequency domain.

Clause 17: The method of Clause 14, wherein the frequency pattern has an aperiodic frequency resource allocation.

Clause 18: The method of any one of Clauses 1-17, wherein the configuration includes an indication that the first set of measurement resources have a periodicity; and obtaining the one or more measurements comprising obtaining the one or more measurements via a periodic instance of the first set of measurement resources that coincides in time with the first set of transmission occasions.

Clause 19: The method of any one of Clauses 1-18, wherein: the first set of measurement resources includes the first set of transmission occasions; the configuration includes an indication of a second set of measurement resources, wherein the second set of measurement resources includes the second set of transmission occasions; and obtaining the one or more measurements comprises obtaining the one or more measurements via the first set of measurement resources and the second set of measurement resources.

Clause 20: The method of Clause 19, wherein: the configuration includes an indication that the second set of measurement resources have a periodicity; and obtaining the one or more measurements comprises obtaining the one or more measurements via a periodic instance of the second set of measurement resources that coincides in time with the second set of transmission occasions.

Clause 21: The method of any one of Clauses 1-20, wherein the one or more measurements include: a first set of measurements associated with the first set of transmission occasions; and a second set of measurements associated with the second set of transmission occasions.

Clause 22: The method of Clause 21, wherein: the first set of measurements includes one or more of a first channel quality indicator, a first received signal strength, or a first received signal quality; and the second set of measurements includes one or more of a second channel quality indicator, a second received signal strength, or a second received signal quality.

Clause 23: The method of any one of Clauses 1-22, wherein the channel state report includes: a first channel quality indicator associated with the first set of transmission occasions; and a second channel quality indicator associated with the second set of transmission occasions.

Clause 24: The method of Clause 23, wherein the channel state report indicates the first channel quality indicator in a first sub-configuration and the second channel quality indicator in a second sub-configuration.

Clause 25: The method of any one of Clauses 1-24, wherein: the configuration includes an indication to report the channel state report with a reporting periodicity; the first set of measurement resources includes a set of channel measurement resources with a measurement periodicity and a set of interference measurement resources with an aperiodic measurement resource allocation; and obtaining the one or more measurements comprises obtaining the one or more measurements via at least the set of interference measurement resources that is arranged in time between periodic instances of the set of channel measurement resources associated with the measurement periodicity.

Clause 26: The method of any one of Clauses 1-25, wherein: the configuration includes an indication to report the channel state report with a reporting periodicity; the first set of measurement resources includes a set of channel measurement resources with a measurement periodicity and a set of interference measurement resources with an aperiodic measurement resource allocation; and obtaining the one or more measurements comprises obtaining the one or more measurements via at least one interference measurement resource of the set of interference measurement resources that is next to, closest to, or after a periodic instance of the set of channel measurement resources associated with the measurement periodicity.

Clause 27: The method of any one of Clauses 1-26, wherein the configuration includes: an indication that the channel state report is a type of report that is dedicated to reporting channel state information associated with an aperiodic interference pattern; the first set of measurement resources includes a set of channel measurement resources and a set of interference measurement resources with an aperiodic measurement resource allocation; an indication to report the channel state report in a reporting occasion associated with an aperiodic reporting pattern; and an indication of the aperiodic reporting pattern.

Clause 28: A method for wireless communications by a first network node comprising: sending, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells; sending a configuration that includes an indication of a first set of measurement resources, wherein the first set of measurement resources includes one or more of: the first set of transmission occasions or the second set of transmission occasions; and obtaining a channel state report that includes an indication of one or more measurements associated with at least the first set of measurement resources.

Clause 29: The method of Clause 28, further comprising obtaining the interference indication from a second network node that serves the one or more neighbor cells.

Clause 30: The method of Clause 29, wherein obtaining the interference indication comprises obtaining, via an Xn interface or an F1 interface, the interference indication from the second network node.

Clause 31: The method of any one of Clauses 28-30, wherein the first set of measurement resources includes one or more of: a set of channel measurement resources or a set of interference measurement resources.

Clause 32: The method of any one of Clauses 28-31, wherein: the interference indication includes an interference pattern that indicates whether the interference is expected to occur in each transmission occasion of the plurality of transmission occasions associated with the uplink-downlink pattern of the one or more serving cells; and the plurality of transmission occasions, in the interference pattern, map to a plurality of slots or symbols in the uplink-downlink pattern.

Clause 33: The method of Clause 32, wherein the uplink-downlink pattern is part of a sub-band full-duplex pattern, in a time domain and a frequency domain, of the one or more serving cells.

Clause 34: The method of Clause 33, wherein the uplink-downlink pattern is based at least in part on a semi-static downlink resource allocation pattern or a predicted downlink resource allocation pattern.

Clause 35: The method of Clause 32, wherein the interference pattern has a periodicity.

Clause 36: The method of Clause 35, wherein the periodicity of the interference pattern matches a periodicity of the uplink-downlink pattern.

Clause 37: The method of Clause 35, wherein the periodicity of the interference pattern is different from a periodicity of the uplink-downlink pattern.

Clause 38: The method of Clause 32, wherein the interference pattern occupies an aperiodic time window.

Clause 39: The method of Clause 32, wherein the interference pattern indicates a set of frequency resources in which the interference is expected to occur in the first set of transmission occasions.

Clause 40: The method of Clause 39, wherein the interference pattern includes an indication of a location and a bandwidth of the set of frequency resources in a frequency domain.

Clause 41: The method of Clause 39, wherein the interference pattern indicates the set of frequency resources per transmission occasion of the first set of transmission occasions.

Clause 42: The method of Clause 39, wherein the interference pattern indicates the set of frequency resources occupies each transmission occasion of the first set of transmission occasions.

Clause 43: The method of Clause 39, wherein the interference pattern indicates the set of frequency resources based on an index associated with a frequency pattern.

Clause 44: The method of Clause 43, wherein the index is per period, per slot, or per symbol associated with the interference pattern.

Clause 45: The method of Clause 43, wherein the frequency pattern has a periodic pattern in the frequency domain.

Clause 46: The method of Clause 43, wherein the frequency pattern has an aperiodic frequency resource allocation.

Clause 47: The method of any one of Clauses 28-46, wherein the configuration includes an indication that the first set of measurement resources have a periodicity; and a periodic instance of the first set of measurement resources coincides in time with the first set of transmission occasions.

Clause 48: The method of any one of Clauses 28-47, wherein: the first set of measurement resources includes the first set of transmission occasions; the configuration includes an indication of a second set of measurement resources, wherein the second set of measurement resources includes the second set of transmission occasions; and the one or more measurements are associated with the first set of measurement resources and the second set of measurement resources.

Clause 49: The method of Clause 48, wherein: the configuration includes an indication that the second set of measurement resources have a periodicity; and the one or more measurements are associated with a periodic instance of the second set of measurement resources that coincides in time with the second set of transmission occasions.

Clause 50: The method of any one of Clauses 28-49, wherein the one or more measurements include: a first set of measurements associated with the first set of transmission occasions; and a second set of measurements associated with the second set of transmission occasions.

Clause 51: The method of Clause 50, wherein: the first set of measurements includes one or more of a first channel quality indicator, a first received signal strength, or a first received signal quality; and the second set of measurements includes one or more of a second channel quality indicator, a second received signal strength, or a second received signal quality.

Clause 52: The method of any one of Clauses 28-51, wherein the channel state report includes: a first channel quality indicator associated with the first set of transmission occasions; and a second channel quality indicator associated with the second set of transmission occasions.

Clause 53: The method of Clause 52, wherein the channel state report indicates the first channel quality indicator in a first sub-configuration and the second channel quality indicator in a second sub-configuration.

Clause 54: The method of any one of Clauses 28-53, wherein: the configuration includes an indication to report the channel state report with a reporting periodicity; the first set of measurement resources includes a set of channel measurement resources with a measurement periodicity and a set of interference measurement resources with an aperiodic measurement resource allocation; and the one or more measurements is associated with at least the set of interference measurement resources that is arranged in time between periodic instances of the set of channel measurement resources associated with the measurement periodicity.

Clause 55: The method of any one of Clauses 28-54, wherein: the configuration includes an indication to report the channel state report with a reporting periodicity; the first set of measurement resources includes a set of channel measurement resources with a measurement periodicity and a set of interference measurement resources with an aperiodic measurement resource allocation; and the one or more measurements is associated with at least one interference measurement resource of the set of interference measurement resources that is next to, closest to, or after a periodic instance of the set of channel measurement resources associated with the measurement periodicity.

Clause 56: The method of any one of Clauses 28-55, wherein the configuration includes: an indication that the channel state report is a type of report that is dedicated to reporting channel state information associated with an aperiodic interference pattern; the first set of measurement resources includes a set of channel measurement resources and a set of interference measurement resources with an aperiodic measurement resource allocation; an indication to report the channel state report in a reporting occasion associated with an aperiodic reporting pattern; and an indication of the aperiodic reporting pattern.

Clause 57: One or more apparatuses, comprising: one or more memories comprising executable instructions; and one or more processors configured to execute the executable instructions and cause the one or more apparatuses to perform a method in accordance with any one of Clauses 1-56.

Clause 58: One or more apparatuses configured for wireless communications, comprising: one or more memories; and one or more processors, coupled to the one or more memories, configured to cause the one or more apparatuses to perform a method in accordance with any one of Clauses 1-56.

Clause 59: One or more apparatuses configured for wireless communications, comprising: one or more memories; and one or more processors, coupled to the one or more memories, configured to perform a method in accordance with any one of Clauses 1-56.

Clause 60: One or more apparatuses, comprising means for performing a method in accordance with any one of Clauses 1-56.

Clause 61: One or more non-transitory computer-readable media comprising executable instructions that, when executed by one or more processors of one or more apparatuses, cause the one or more apparatuses to perform a method in accordance with any one of Clauses 1-56.

Clause 62: One or more computer program products embodied on one or more computer-readable storage media comprising code for performing a method in accordance with any one of Clauses 1-56.

Clause 63: One or more apparatuses configured for wireless communications, comprising: a processing system that includes one or more processors and one or more memories coupled with the one or more processors, the processing system configured to cause the one or more apparatuses to perform a method in accordance with any one of Clauses 1-56.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells;
obtain a configuration that includes an indication of a first set of measurement resources, wherein the first set of measurement resources includes one or more of: the first set of transmission occasions or the second set of transmission occasions;
obtain one or more measurements via at least the first set of measurement resources; and
send a channel state report that includes an indication of the one or more measurements.

2. The apparatus of claim 1, wherein the first set of measurement resources includes one or more of: a set of channel measurement resources or a set of interference measurement resources.

3. The apparatus of claim 1, wherein:
the interference indication includes an interference pattern that indicates whether the interference is expected to occur in each transmission occasion of the plurality of transmission occasions associated with the uplink-downlink pattern of the one or more serving cells; and
the plurality of transmission occasions, in the interference pattern, map to a plurality of slots or symbols in the uplink-downlink pattern.

4. The apparatus of claim 3, wherein the interference pattern occupies an aperiodic time window.

5. The apparatus of claim 3, wherein the interference pattern indicates a set of frequency resources in which the interference is expected to occur in the first set of transmission occasions.

6. The apparatus of claim 5, wherein the interference pattern includes an indication of a location and a bandwidth of the set of frequency resources in a frequency domain.

7. The apparatus of claim 5, wherein the interference pattern indicates the set of frequency resources based on an index associated with a frequency pattern.

8. The apparatus of claim 1, wherein
the configuration includes an indication that the first set of measurement resources have a periodicity; and
to cause the UE to obtain the one or more measurements, the processing system is configured to cause the UE to obtain the one or more measurements via a periodic instance of the first set of measurement resources that coincides in time with the first set of transmission occasions.

9. The apparatus of claim 1, wherein:
the first set of measurement resources includes the first set of transmission occasions;
the configuration includes an indication of a second set of measurement resources, wherein the second set of measurement resources includes the second set of transmission occasions; and
to cause the UE to obtain the one or more measurements, the processing system is configured to cause the UE to obtain the one or more measurements via the first set of measurement resources and the second set of measurement resources.

10. The apparatus of claim 9, wherein:
the configuration includes an indication that the second set of measurement resources have a periodicity; and
to cause the UE to obtain the one or more measurements, the processing system is configured to cause the UE to obtain the one or more measurements via a periodic instance of the second set of measurement resources that coincides in time with the second set of transmission occasions.

11. The apparatus of claim 1, wherein the one or more measurements include:
a first set of measurements associated with the first set of transmission occasions; and
a second set of measurements associated with the second set of transmission occasions.

12. The apparatus of claim 11, wherein:
the first set of measurements includes one or more of a first channel quality indicator, a first received signal strength, or a first received signal quality; and
the second set of measurements includes one or more of a second channel quality indicator, a second received signal strength, or a second received signal quality.

13. The apparatus of claim 1, wherein the channel state report includes:
a first channel quality indicator associated with the first set of transmission occasions; and
a second channel quality indicator associated with the second set of transmission occasions.

14. The apparatus of claim 1, wherein:
the configuration includes an indication to report the channel state report with a reporting periodicity;
the first set of measurement resources includes a set of channel measurement resources with a measurement periodicity and a set of interference measurement resources with an aperiodic measurement resource allocation; and
to cause the UE to obtain the one or more measurements, the processing system is configured to cause the UE to obtain the one or more measurements via at least the set of interference measurement resources that is arranged in time between periodic instances of the set of channel measurement resources associated with the measurement periodicity.

15. The apparatus of claim 1, wherein:
the configuration includes an indication to report the channel state report with a reporting periodicity;
the first set of measurement resources includes a set of channel measurement resources with a measurement periodicity and a set of interference measurement resources with an aperiodic measurement resource allocation; and
to cause the UE to obtain the one or more measurements, the processing system is configured to cause the UE to obtain the one or more measurements via at least one interference measurement resource of the set of interference measurement resources that is next to, closest to, or after a periodic instance of the set of channel measurement resources associated with the measurement periodicity.

16. The apparatus of claim 1, wherein the configuration includes:
an indication that the channel state report is a type of report that is dedicated to reporting channel state information associated with an aperiodic interference pattern;
the first set of measurement resources includes a set of channel measurement resources and a set of interference measurement resources with an aperiodic measurement resource allocation;
an indication to report the channel state report in a reporting occasion associated with an aperiodic reporting pattern; and
an indication of the aperiodic reporting pattern.

17. An apparatus for wireless communications, comprising a processing system that includes one or more processors and one or more memories coupled with the one or more processors, the processing system configured to cause a first network node to:
send, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells;
send a configuration that includes an indication of a first set of measurement resources, wherein the first set of measurement resources includes one or more of: the first set of transmission occasions or the second set of transmission occasions; and
obtain a channel state report that includes an indication of one or more measurements associated with at least the first set of measurement resources.

18. The apparatus of claim 17, wherein the processing system is configured to cause the first network node to obtain the interference indication from a second network node that serves the one or more neighbor cells.

19. The apparatus of claim 18, wherein to cause the first network node to obtain the interference indication, the processing system is configured to cause the first network node to obtain, via an Xn interface or an F1 interface, the interference indication from the second network node.

20. A method for wireless communications by a user equipment (UE), comprising:
obtaining, via one or more serving cells, an interference indication of whether interference associated with one or more neighbor cells is expected to occur in one or more transmission occasions of a plurality of transmission occasions associated with an uplink-downlink pattern of the one or more serving cells, wherein the interference indication indicates that the interference is expected to occur in a first set of transmission occasions of the plurality of transmission occasions, wherein the interference indication indicates that the interference is not expected to occur in a second set of transmission occasions of the plurality of transmission occasions, and wherein the interference is associated with downlink communications via the one or more serving cells;
obtaining a configuration that includes an indication of a first set of measurement resources, wherein the first set of measurement resources includes one or more of: the first set of transmission occasions or the second set of transmission occasions;
obtaining one or more measurements via at least the first set of measurement resources; and
sending a channel state report that includes an indication of the one or more measurements.
